(19) United States
(12) Patent Application Publication
(10) Pub. No.: US 2024/0152541 A1
(43) Pub. Date: May 9, 2024

(54) TEXT MINING METHOD FOR TREND IDENTIFICATION AND RESEARCH CONNECTION

(71) Applicant: The Trustees of Princeton University, Princeton, NJ (US)

(72) Inventors: Junjie ZHU, Princeton, NJ (US); Zhiyong Jason REN, Princeton, NJ (US)

(73) Assignee: The Trustees of Princeton University, Princeton, NJ (US)

(21) Appl. No.: 18/281,710

(22) PCT Filed: Mar. 14, 2022
(86) PCT No.: PCT/US2022/020153

§ 371 Date: Sep. 12, 2023

Related U.S. Application Data
(60) Provisional application No. 63/160,191, filed on Mar. 12, 2021.

(51) Int. Cl. G06F 16/35

(52) U.S. Cl. CPC G06F 16/355

(57) ABSTRACT

Various embodiments comprise systems, methods, architectures, mechanisms, apparatus, and improvements thereof for the processing of text-based content such as from a collection of content items including unstructured and structured text of different formats and types so as to automatically derive therefrom an organized, trend-indicative representation of underlying topics/subtopics within the collection of content items.

### CROSS-REFERENCE TO RELATED APPLICATION

This application claims the benefit of U.S. Provisional Patent Application Ser. No. 63/160,191 filed Mar. 12, 2021, which Application is incorporated herein by reference in its entireties.

### FIELD OF THE DISCLOSURE

The present invention relates to the fields of information science and data mining and, more particularly, to the processing of text-based content such as from a collection of research papers including unstructured and structured text of different formats and types so as to automatically derive therefrom an organized, trend-indicative representation of underlying topics/subtopics within the collection of research papers.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Conventional (numerical) data mining, which is usually based on structured and homogenous data, is generally ineffective and certainly inefficient within the context of unstructured and structured texts with different formats and types. Further, such data mining as applied via current literature search tools requires significant user input/control such as via the to input of specific keywords, authors, journal title, etc.

### SUMMARY

Various deficiencies in the prior art are addressed by systems, methods, architectures, mechanisms, apparatus, and improvements thereof enabling the processing of text-based content such as from a collection of content items including unstructured and structured text of different formats and types so as to automatically derive therefrom an organized, trend-indicative representation of underlying topics/subtopics within the collection of content items.

The collection of content items may comprise text-based content items from text-based sources where text is directly extracted therefrom (e.g., text from research papers, as well as text from non-research papers such as from news sources, periodicals, books, reports, websites, and so on) and non-text based content items from non-text-based resources where text is derived therefrom (e.g., text derived from speech-to-text or voice recognition programming such as applied to audio content items and/or audiovisual content items (e.g., research related content and/or non-research related content provided as audio presentations, audiovisual presentations, streaming media and so on). Further, text in other languages may be subjected to automatic translation so as to conform all text into a common language for further processing (e.g., English).

Various embodiments support text-based mining of the collection of research and/or non-research content items via a natural language processing-based method that enables flexible, customized, and comprehensive text mining research such as, illustratively, configured for use with research papers presented using unstructured and structured texts with different formats and types using linguistic and statistical techniques.

Various embodiments include a computer-implemented method configured to maximize an integration between data science and domain knowledge, and to employ deep text preprocessing tools to provide a new type of data collection, organization, and presentation of trend-indicative representations of underlying topics/subtopics within a collection of content items of interest.

Various embodiments will be discussed within the context of a collection of content items (data sets) including research papers published over a 20-year time period by a scholarly journal, illustratively the journal of Environmental Science & Technology, wherein the collection of content items is processed to automatically derive therefrom an organized, trend-indicative representation of underlying topics/subtopics included therein to demonstrate the evolution of research themes, revealed underlying connections among different research topics, identified trending up and emerging topics, and a discerned distribution of major domain-based groups.

A method of processing an unstructured collection of text-based content items to automatically derive therefrom a trend-indicative representation of topical information according to an embodiment comprises: pre-processing text within each of the text-based content items in accordance with presentation-norming and text-norming to provide a structured collection of the text-based content items, the presentation-norming comprising detection and combination of principle terms, the text-norming comprising word stemming; automatically selecting keywords in accordance with a keyword usage frequency analysis and a keyword co-occurrence analysis of the content items within the structured collection of the text-based content items; dividing the structured collection of the text-based content items into at least one of spatial, topical, geographical, demographical, and temporal groups of structured text-based content items; determining for each keyword a respective normalized cumulative keyword frequency (Fᵥₐᵣ), normalized cumulative keyword frequency for variable p (F_{var p}), normalized cumulative keyword frequency for variable q (F_{var q}), and trend factor; and generating an information product depicting the major and minor domains of interest. The method may further include (in addition to or instead of the trend factor determination) identifying, using rules-based classification, major and minor domains of interest within the structured collection of the text-based content items.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts a graphical representation of an information gathering, processing, and broadcasting tool according to an embodiment;

FIG. 2 depicts a flow diagram of method in according to an embodiment;

FIG. 3 graphically depicts a tabular representation of various challenges addressed by text-norming and presentation-norming processes according to an embodiment;

FIG. 4 depicts a flow diagram of an iterative rule-based classification method according to an embodiment;

FIGS. 5-18 graphically depict various visualizations in accordance with the embodiments.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It must be noted that as used herein and in the appended claims, the singular forms “a”, “an”, and “the” include plural referents unless the context clearly dictates otherwise.

Various deficiencies in the prior art are addressed by systems, methods, architectures, mechanisms, apparatus, and improvements thereof enabling the processing of text-based content such as from a collection of content items including unstructured and structured text of different formats and types so as to automatically derive therefrom an organized, trend-indicative representation of underlying topics/subtopics within the collection of content items.

The collection of content items may comprise text-based content items from text-based sources where text is directly extracted therefrom (e.g., text from research papers, as well as text from non-research papers such as from news sources, periodicals, books, websites, and so on) and non-text based content items from non-text-based resources where text is derived therefrom (e.g., text derived from speech-to-text or voice recognition programming such as applied to audio content items and/or audiovisual content items (e.g., research related content and/or non-research related content provided as audio presentations, audiovisual presentations, streaming media and so on). Further, text in other languages may be subjected to automatic translation so as to conform all text into a common language for further processing (e.g., English).

Various embodiments support text-based mining of the collection of research and/or non-research content items via a natural language processing-based method that enables flexible, customized, and comprehensive text mining research such as, illustratively, configured for use with research papers presented using unstructured and structured texts with different formats and types using linguistic and statistical techniques.

Various embodiments include a computer-implemented method configured to maximize an integration between data science and domain knowledge, and to employ deep text preprocessing tools to provide a new type of data collection, organization, and presentation of trend-indicative representations of underlying topics/subtopics within a collection of content items of interest.

The embodiments disclosed and discussed herein find applicability in many situations or use cases. For example, disclosed statistical and machine learning methodologies enable customized and accurate collection, organization, and presentation of trending/popular topics within a dataset or collection of content items with limited human intervention, which is distinct from existing (literature) search methods that requires human inputs on titles, keywords, authors, institutions, etc. The developed programs may be used by clients on emerging topic identification, research, development, and investment. For example, one can develop a website, RSS feeds, an application or app to provide in-time research information to individual and institutional as customized first-hand information suitable for use in both programmatic and non-programmatic decision making.

The embodiments disclosed and discussed herein enable identification of user defined research topics or areas of interest with limited human intervention; automatically identifying such topics or areas of interests in accordance with client interests/goals so as to provide unbiased and timely updates on these topics/areas of interest.

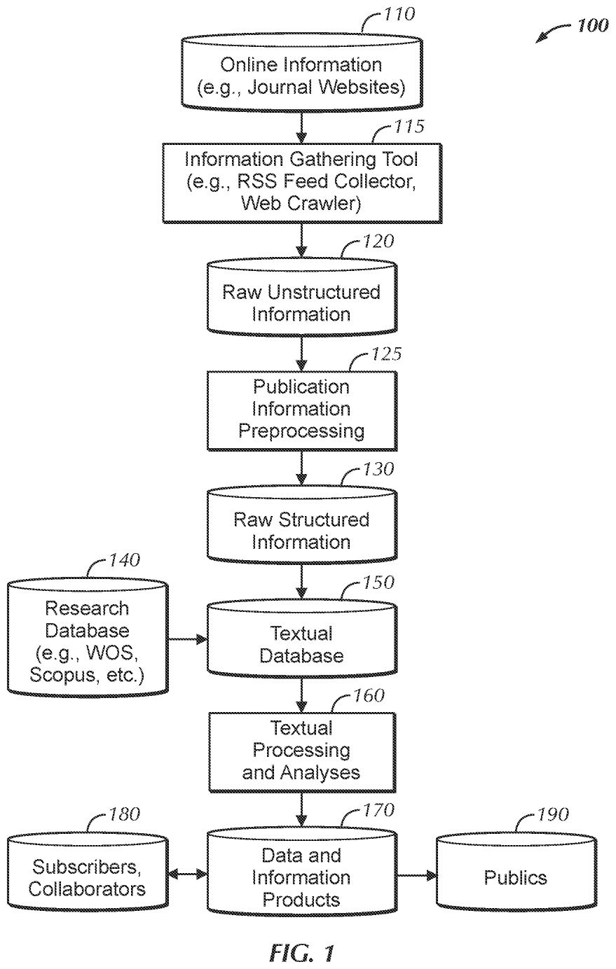

FIG. 1 depicts a graphical representation of an information gathering, processing, and broadcasting tool according to an embodiment. Specifically, the tool 100 of FIG. 1 comprises a plurality of information processing systems and elements configured to perform various functions in accordance with one embodiment. The configuration and function of the various elements of the tool 100 may be modified in numerous ways, as will be appreciated by those skilled in the art.

Referring to FIG. 1, relevant information from a source of online information 110, such as information from Journal websites and the like, is accessed via an information gathering tool 115 such as an RSS feed collector, web crawler and the like to provide raw unstructured information which is stored in a database 120.

The raw unstructured information stored in the database 120 the subject to various preprocessing operations via a publication information preprocessing tool 125 to provide thereby raw unstructured information, which is stored in a database 130 and subsequently provided to a textual database 150.

The textual database 150 may further include information provided via a research database 140, such as Web of Science, PubMed's API, Elsevier's Scopus, etc.

Information within the textual database 150 is subjected to various textual processing and analysis processes 160 in accordance with the various embodiments to provide thereby data and information products 170. The data and information products 170 may be further refined or simply used by customers, subscribers, and/or collaborators 180. The data and information products 170 may also be provided to public users 190.

The above described tool generally reflects an automated mechanism by which unstructured information appropriate to a particular task or research endeavor is extracted from a source, subjected to various preprocessing operations to form structured information for use any textual database which itself is subjected to textual processing and analysis functions in accordance with the various embodiments to provide useful processed data and information products which may be deployed to end-users to assist in decision-making and/or other functions.

In various embodiments, a customer request for an information product includes source material identification sufficient to enable automatic retrieval of a collection of unstructured content items, which are then processed in accordance with the various embodiments as depicted below to derive data results/information sufficient to generate an information product (e.g., report, visualization, decision tree nodes, etc.) responsive to the customer request.

Optionally the information product may include or comprise various visualizations of keyword trend factors and/or identified major/minor domains (topics) of collection according to various visualization schemes

Various elements or portions thereof such as depicted in FIG. 1 and described throughout this Specification may be implemented in hardware or in hardware combined with software to provide the functions described herein, such as implemented at least in part as computing devices having processing, memory, input/output (I/O), mass storage, communications, and/or other capabilities as is known in the art. These implementations may be via one or more individual computing devices, computer servers, computer networks, and so on. These implementations may be via compute and memory resources configured to support one or more individual computing devices, computer servers, computer networks, and so on such as provided in a data center or other virtualized computing environment.

Thus, the various elements or portions thereof have or are associated with computing devices of various types, though generally a processor element (e.g., a central processing unit (CPU), graphic processing unit (GPU), or other suitable processor(s)), a memory (e.g., random access memory (RAM), read only memory (ROM), and the like), various communications, input/output interfaces (e.g., GUI delivery mechanism, user input reception mechanism, web portal interacting with remote workstations and so on) and the like.

Broadly speaking, the various embodiments are implemented using data processing resources (e.g., one or more servers, processors and/or virtualized processing elements or compute resources) and non-transitory memory resources (e.g., one or more storage devices, cloud storages, memories and/or virtualized memory elements or storage resources). These processing and memory resources (e.g., compute and memory resources configured to perform the various processes/methods described herein) may be configured to stored and execute software instructions to provide thereby various dataset retrieval, processing, and information product output functions such as described herein.

As such, the various functions depicted and described herein may be implemented at the elements or portions thereof as hardware or a combination of software and hardware, such as by using a general purpose computer, one or more application specific integrated circuits (ASIC), or any other hardware equivalents or combinations thereof. In various computer-implemented embodiments, computer instructions associated with a function of an element or portion thereof are loaded into a respective memory and executed by a respective processor to implement the respective functions as discussed herein. Thus various functions, elements and/or modules described herein, or portions thereof, may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory, or stored within a memory within a computing device operating according to the instructions.

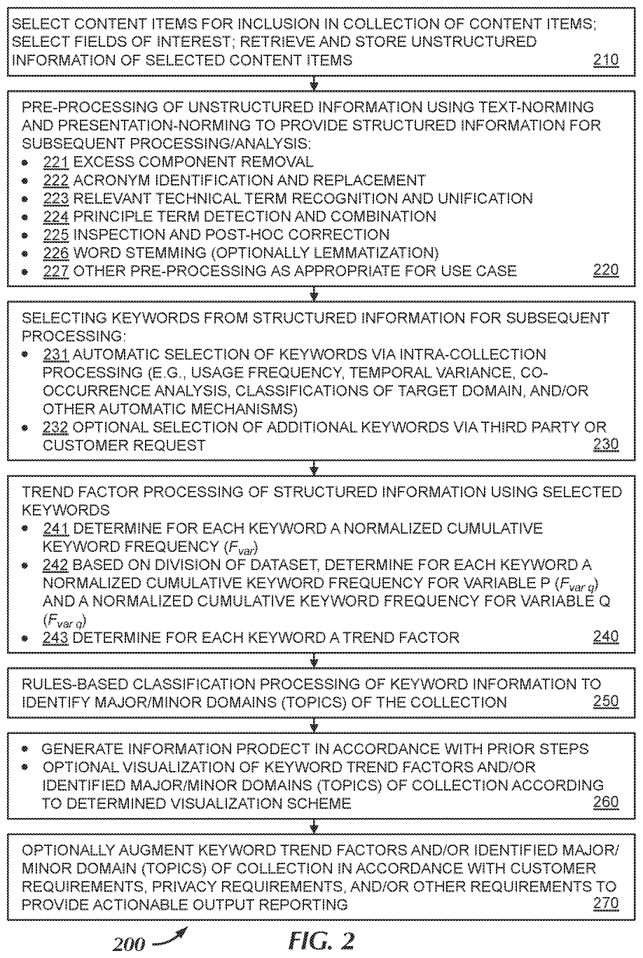

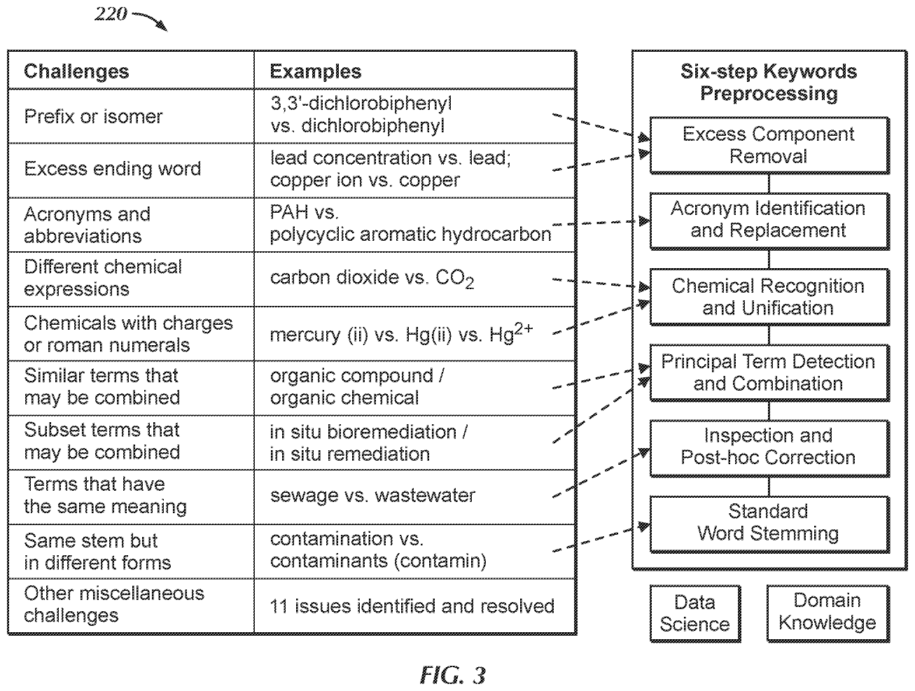

FIG. 2 depicts a flow diagram of method in accordance with an embodiment. Specifically, the method 200 of FIG. 2 is suitable for use in processing a non-homogeneous collection of text-based content items to automatically derive therefrom a trend-indicative representation of topical or domain information, which derived information may be visualized according to an automatically determined visualization mechanism augmented for subsequent use by a customer, and so on.

At step 210, the method 200 selects content items for inclusion in a collection of content items, selects fields of interest, retrieves the relevant content items, and stored the content items as unstructured information in a database, server, or other location. That is, prior to the processing of a relevant dataset or collection of content items, the relevant dataset or collection of content items must be selected and acquired so that the various automated steps of the method 200 may be more easily invoked.

As an example to illustrate the various embodiments, the inventors processed a collection of content items (data sets) including research papers published over a 20-year time period by a scholarly journal, illustratively 29,188 papers from 2000 through 2019 appearing in the journal Environmental Science & Technology (ES&T), to automatically derive therefrom an organized, trend-indicative representation of underlying topics/subtopics included therein so as to demonstrate an evolution of research themes, revealed underlying connections among different research topics, identified trending up and emerging topics, and a discerned distribution of major domain-based groups.

The raw data of the full publication records from 29,188 publications spanning 67 fields (each field contains a dimension of publication information, such as publisher and authors) for ES&T from 2000 to 2019, are retrieved. A preliminary screening step is taken to select 11 fields that include publication type, title, abstract, keywords (based on Keywords Plus), correspondence, year, month/day, volume, issue, citation count (“Z9”), and digital object identifier. In this illustrative study, research articles and review papers are retained while other types of publications, such as news items, editorial materials (e.g., viewpoints and comments), and letters to editors, are excluded because they usually didn't have system-generated keywords. After screening, 25,836 raw records remained for the subsequent analyses.

At step 220, the method 200 performs various pre-processing steps upon the unstructured information representation of the collection of content items using various text-norming and presentation-norming processes to provide thereby a structured information representation of the collection of content items suitable for use in subsequent processing/analysis steps.

### (A) Deep Text/Keyword Preprocessing Methodology

### Keyword Preprocessing

Keywords preprocessing is deemed by the inventors to be critical in obtaining reliable analysis results because variants and synonyms are frequently found in raw data, and insufficient treatments can underestimate or miscalculate term frequencies. First, a focus is placed on keywords with frequencies higher than a minimum threshold (e.g., ≥10), which helps retain valuable information in a more time-efficient way. Second, combinations of keywords or screened to avoid being too specific or too general. For example, the terms “multiwalled carbon nanotube” and “carbon nanotube” may be placed in the same group, while the term “nanomaterials” may be placed in a separate group. In addition, the various embodiments utilize two methods frequently used to normalize a word to its common, base form; namely, lemmatization and stemming. Lemmatization is a dictionary-based method to linguistically remove inflectional endings based on the textual environment, whereas stemming is a process to cut off the last several characters to return the word to a root form. Because the analyzing targets or the keywords, stemming is subjective as the most appropriate method for this example/study.

Various embodiments also utilize neural networks-based natural language processing (NLP) tools, such as (in the context of the illustrative embodiment) the ChemListem tool, which is a deep neural networks-based Python NLP package for chemical named entity recognition (NER) and may be used to identify word-based chemicals to address issues like prefix and different chemical names because capital letters are not available. Inspections may be applied to all issues to enhance overall preprocessing performance based on domain knowledge.

Further with respect to stemming, various embodiments use one or more stemming type processes as appropriate for the dataset/content items. Briefly, stemming is a crude process to cut off the last several characters. Stemming is a better way in our case, and all keywords are lowercased and keywords that are more than four letters are stemmed before other preprocessing steps. Python NLP package nltk is used to perform the stemming and the “SnowballStemmer” algorithm is used. Specific rules used in stemming can be complex; a few basic rules are introduced below (it is noted that Porter's algorithm is a popular algorithm for the stemming of English language text). Some typical rules:
sses→ss; ies→i; ational→ate; tional→tion
Weight of word sensitive rules
(m>1) EMENT: replacement→replac; cement→cement

Given that a word is in a form of [C](VC)^{m}[V], where C and V are consonant and vowel, respectively; m is the measures of a word or part of a word. The rules for removing a suffix, (condition) S1→S2, are usually based on m. This means that S1 will be replaced by S2 if the word ends with Si and the stem before S1 meets the condition. In the above example, S1 is ‘EMENT’ and S2 is null, which maps replacement to replac, but not cement to c, because replac is a word part with m=2. There are many other specific rules and information associated with the Porter's algorithm. Snowball is a revised and improved version of the Porter's algorithm when the inventor, Martin Porter, realized that the original algorithm could give incorrect results in many researchers' published works.

As depicted in FIG. 2, at step 221 an excess component removal process is performed. The excess component removal process is configured to use natural language processing-based entity recognition (NER) to pre-select (identify) text indicative of both simple and complex technical terms of art (words, and/or phrases) as used in various scientific and non-scientific disciplines (e.g., different fields of scientific research or inquiry, various engineering disciplines, mathematical principles, medical terms, legal terms, cultural terms, and so on), which technical/specialized terms of art may be presented as words/phrases or other textual representations within the relevant collection of content items or datasets. This step operates to normalize technical/specialized terms of art in accordance with a commonality of usage or normalization of usage of each technical/specialized term or art so that different or varying use of technical/specialized terms having a common meaning is normalized to remove excess information where such excess information distracts from technical/specialized terms being expressed in a manner that is sufficiently distinct for use by subsequent processing steps.

Within the context of the illustrative example, the technical/specialized terms of primary interest from all retrieved publication records of the journal of Environmental Science & Technology for the relevant time period are retrieved and processed in the above-described manner to provide a consistently similar representation of substantially similar technical/specialized terms, especially of the technical/specialized terms of primary interest; namely, those associated with organic chemicals and, to a lesser extent, other chemicals, materials, geological structures, and the like.

For example, with respect to organic chemicals, a rule according to the embodiments may be applied to typical isomers that contain number, hyphen, and more than three letters while the first element must be number, and number and letters are not successive. Excess prefix, initial words, and ending words may be eliminated for all non-single-word keywords. For non-chemical keywords, different types of word connection (AB, A B, A-B, A/B, and A and B; where A and B are sub words) are identified and treated; similar patterns (ABC, ABCD, etc.) of word connection may all be preprocessed.

As depicted in FIG. 2, at step 222 an acronym (or abbreviation) identification and replacement process is performed. Specifically, a text-based method is used to recursively detect initial letters-based acronyms (e.g., X-letter acronyms where X is 2, then 3, then 4, and so on). Identified X-letter acronyms are use to screen text representing other X-letter acronym candidates with defined stop-words. Candidates are further selected while each of them should have corresponding, first-letters-matched X-word term(s). Corresponding articles are identified and reviewed to determine the final acronyms based on domain knowledge. An acronym is a combination of initial letters or partial-initial letters of a terminology, typically from three to five letters. The same method without the first-letters-matched step may be used to detect the partial initial letters-based acronyms.

Within the context of the illustrative example, the acronyms from all retrieved publication records of the journal of Environmental Science & Technology for the relevant time period are identified in the above-described manner.

As depicted in FIG. 2, at step 223 a relevant technical term recognition and unification process is performed. Within the context of the illustrative example, this process is primarily directed to chemical terminology recognition and unification. Specifically, inorganic chemicals have different expressions (name or formula) in the raw data. The method is configured for identifying each chemical name using a Chemical NER to screen for chemicals with relatively high frequency. Words that contain any of the typical formats of roman numerals or charges associated with a chemical are identified and replaced correspondingly. Different formats of chemical expressions of metals, for example, are unified to a single, base name only except when the metal has different names in different valences and is not the single element in the chemical. Other types of chemicals, materials, and the like are processed in a similar manner to achieve coherent and simplified representations thereof.

As depicted in FIG. 2, at step 224 a principle term detection and combination process is performed. This process is primarily directed to detecting the same first one or first several (e.g., 2, 3, 4, 5, etc.) words, which are then denoted as “principal terms.” Any frequent keywords having the same principal terms (e.g., only the last word varying) are identified as candidates, and subsequently reviewed using domain knowledge to decide if they are sufficiently similar or not. A similar method is applied to the keywords with the same last or last several (e.g., 2, 3, 4, 5, etc.) words.

As depicted in FIG. 2, at step 225 an inspection and post-hoc correction process is performed. This process is primarily directed to automatically addressing data quality issues that may arise in any of the above steps 221-224. For example, an initial inspection may be used to prepare an effective preprocessing method, and a final inspection taken to determine and combine variants and synonyms. In addition, a post-hoc inspection and correction is conducted to refine the final treated keywords database and improve the reliability of results. The post-hoc step help to address many issues, such as same-meaning terms, subset terms, conversion between very similar/related languages (e.g., American/British English), conversion between related languages, capital/lower case/mixed formats of letters, and other miscellaneous issues. Same-meaning terms and subset terms are identified based on domain-knowledge comparison and statistical analyses of words, such as corresponding analysis, principal component analysis, and discriminant analysis. American/British English conversion is realized using typical conversion dictionary and additional terminologies in the domain areas. Capital/lower case/mixed formats of letters are managed separately, which are used to identify acronym, abbreviation, and chemicals.

As depicted in FIG. 2, at step 226 a word stemming process is performed (optionally including a lemmatization process). Specifically, the word stemming (optionally also lemmatization) process is configured to convert all keywords as needed to be lower case rather than partially or wholly capitalized, and to further truncate these keywords to be of a common maximum length (illustratively four letters max, though other embodiments may truncate to more or fewer word lengths such as five or three letters). Finally, words with irregular plural forms may be corrected immediately or marked fur subsequent correction. This step operates to normalize the text in accordance with a common word length and a consistent expression of singular/plural form.

Within the context of the illustrative example, the text from all retrieved publication records of the journal of Environmental Science & Technology for the relevant time period is retrieved and processed to normalize the text in the above-described manner.

As depicted in FIG. 2, at step 227 various other pre-processing processing functions may be performed as appropriate to the use case, customer request/requirements, and so on. These steps may be performed prior to, after, or in conjunction with other pre-processing steps 220 as described herein.

For example, other types of preprocessing may comprise converting non-text unstructured information into text-based structured information. That is, a collection of content items may comprise text-based content items from text-based sources where text is directly extracted therefrom (e.g., text from research papers, as well as text from non-research papers such as from news sources, periodicals, books, reports, websites, and so on) and/or non-text based content items from non-text-based resources where text is derived therefrom (e.g., text derived from speech-to-text or voice recognition programming such as applied to audio content items and/or audiovisual content items (e.g., research related content and/or non-research related content provided as audio presentations, audiovisual presentations, streaming media and so on). Further, text in other languages may be subjected to automatic translation so as to conform all text into a common language for further processing (e.g., English). As such, various other processing steps 227 may be used to convert unstructured non-text information into text-based structured information, to convert text-based unstructured or structured information from various languages to a normative or base language, and so on.

FIG. 3 graphically depicts a tabular representation of various challenges addressed by text-norming and presentation-norming processes according to an embodiment. Specifically, FIG. 3 depicts examples of challenges addressed by steps 221-226 as described above. By addressing these and other challenges and/or limitations in the content items within the collection, the quality of the collection-representative data is increased which enables literature mining and other processes to yield deeper and more reliable results.

### Title-Based Keyword Generation

In various embodiments, in addition to the original keywords pretreatment or preprocessing, a method is also applied to generate keywords or terminologies from a title or/and abstract of each content item (e.g., research paper) based on the list of existing keywords. The title or abstract are tokenized by n-grams (n=1, 2, 3, 4, etc.); generated tokens are then converted to lowercase and removed (single) stop-words (the most common words, such as “to” and “on”).

For example, keyword-candidates are first identified based on the original keyword list, and candidates that contained more information are retained when there are multiple similar for each paper. To retrieve more consistent terms and avoid using redundant information, the various embodiments first process all the tokenized terms based on the aforementioned methods, identify keyword-candidates based on the original keyword list (frequency >1), and only retain candidates that contain more information when there are multiple similar terms (e.g., use drinking water rather than water) for each paper. Candidates are deleted when similar Keyword Plus-based keywords are already available for the same paper, and stemming is applied to the final expanded keywords before subsequent analyses.

Returning to the method 200 of FIG. 2, at step 230, the method 200 invokes various selection mechanisms to select keyword thereby from the structured information for subsequent processing. It is noted that the term “keyword” as used herein should be treated as a relatively broad term in that it includes not only “keywords” identified by article authors, but also other searchable terms/terminologies such as author name(s), affiliation(s), and user defined terms as well.

As depicted in FIG. 2, at step 231 an automatic selection of keywords via intra-collection processing is performed (e.g., usage frequency, temporal variance, co-occurrence analysis, classifications of target domain(s) of interest, and/or other automatic mechanisms).

As depicted in FIG. 2, at optional step 232 a selection of additional keywords via third party or customer request is performed.

### (B) Trend Factor Methodology

Various embodiments contemplate that the dataset if split into two parts based on the nature of variable (e.g., spatial, topical, geographical, demographical, and temporal groups); namely, variable p and variable q. A keyword with a higher frequency in the variable q but a lower frequency in the variable p suggests that keyword is more likely to be trending from p to q, and vice versa. In various other embodiments, the dataset is split into three or more parts so as to provide a more detailed view of changes in up or down trend data for keywords.

Returning to the method 200 of FIG. 2, at step 240 the method 200 performs trend factor processing of structured information using all or substantially all of the selected keywords.

As depicted in FIG. 2, at step 241 a respective normalized cumulative keyword frequency (Fᵥₐᵣ) is determined for each keyword as will be discussed below in more detail.

As depicted in FIG. 2, at step 242, based on a division of dataset into variable p and variable q, a respective normalized cumulative keyword frequency for variable p (F_{var p}) and a respective normalized cumulative keyword frequency for variable q (F_{var q}) is determined for each keyword, as will be discussed below in more detail. The division of the dataset may be based on and trend-indicative metric of interest, such as temporal (e.g., change in keyword frequency/usage over time), geospatial (e.g., change in position of keywords with respect to other keywords/datasets), and/or other variations.

As depicted in FIG. 2, at step 243 a respective trend factor is determined for each keyword as will be discussed below in more detail.

While the processing of step 240 is depicted as occurring before the processing of step 250, it is noted that the processing of step 240 is entirely independent from the processing of step 250. In some embodiments, only the processing of step 240 is performed. In some embodiments, only the processing of step 250 is performed. In some embodiments, the processing of each of steps 240 and 250 is performed, and such processing may occur in any sequence (i.e., 240-250 or 250-240), since these each of these steps 240/250 is an independent processing step benefitting from the deep text preprocessing and data preparations steps 220-230 described above.

### Keywords Trend Analysis

Trend analysis of keywords can help to better understand distribution of domains, topics of interest, and the like within a dataset (e.g., research topics within the dataset of the illustrative example). Trend analysis of keywords may be based on temporal, spatial, topical, geographical, and demographical groups within the structured text-based content items.

In various embodiments, a normalized cumulative keyword frequency (Fᵥₐᵣ) is calculated based on a keyword frequency (fᵥₐᵣ) and number of papers (Nᵥₐᵣ), depending on the analyzing variables (e.g., temporal, spatial, topical, geographical, and demographical). The normalized frequency makes it possible to provide a fair comparison of domains/topics. The variables p and (F_{var p}) or q (F_{var q}) normalized cumulative keyword frequencies are defined to represent the number of keyword-related papers (or other content items) per α (e.g., =1000) papers based on domain scope of p and q, respectively. To reflect the trend, an indicator denoted herein as trend factor is calculated by the logarithm value of the ratio of F_{var q} to F_{var p}.

$${F}_{var} = \frac{{\sum }_{var = i}^{j} {f}_{var}}{{\sum }_{var = i}^{j} {N}_{var}} ( if i \neq j ) = \frac{{f}_{i}}{{N}_{i}} ( if i = j ) \qquad ( 1 )$$

$${F}_{var p} = α \times \frac{{\sum }_{FIRST p 1}^{LAST p 2} {f}_{var p}}{{\sum }_{FIRST p 1}^{LAST p 2} {N}_{var p}} and {F}_{var q} = α \times \frac{{\sum }_{FIRST q 1}^{LAST q 2} {f}_{var q}}{{\sum }_{FIRST q 1}^{LAST q 2} {N}_{var q}} \qquad ( 2 )$$

$$Trend factor = log ( \frac{{F}_{var q}}{{F}_{var p}} ) \qquad ( 3 )$$

For better data presentation of the results of the illustrative example, 20 years of data (content items) is divided into two periods (2000-2009, 2010-2019). If a keyword is found at a higher frequency in the most recent decade (2010-2019) but a lower frequency in the past decade (2000-2009), the increasing frequency suggests that keyword is more likely to be a trending up, and vice versa.

To extract and visualize the trending up keywords, the normalized cumulative keyword frequency (F_{yrs}) is calculated based on a keyword frequency (f_{yrs}) and number of papers (N_{yrs}) depending on the analyzing period (years from i to j). The normalized frequency makes it possible to provide a fair comparison of topics during different periods, because annual publication numbers change over the time. The past (Fₚₐₛₜ) or current (F_{current}) normalized cumulative keyword frequencies are defined to stand for the number of keyword-related papers per 1000 papers in the past or current periods, respectively. To reflect the trend, an indicator denoted herein as a trend factor is calculated as the logarithm value of the ratio of F_{current} to Fₚₐₛₜ.

A majority of trending up keywords are determined based on the trend factor and F_{current} To guarantee a steady popularity, an additional criterion is applied to exclude keywords with a much lower frequency in the most recent years. To minimize a possible “edge effect” resulted by the arbitrary break point, additional criteria are used to screen the candidates that did not meet the original trend factor.

For example, within the context of the illustrative example, trend analysis of keywords can help to better understand temporal evolution of research topics. For better data presentation, 20 years of data is divided into two periods (2000-2009, 2010-2019). If a keyword is found at a higher frequency in the most recent decade (2010-2019) but a lower frequency in the past decade (2000-2009), the increasing frequency suggests that keyword is more likely to be a trending up, and vice versa. To extract and visualize the trending up keywords, the normalized cumulative keyword frequency (F_{yrs}) is calculated based on a keyword frequency (f_{yrs}) and number of papers (N_{yrs}), depending on the analyzing period (years from i to j). The normalized frequency makes it possible to provide a fair comparison of topics during different periods, because annual publication numbers change over the time. The past (Fₚₐₛₜ) or current (F_{current}) normalized cumulative keyword frequencies are defined to represent the number of keyword-related papers per 1000 papers in the past or current periods, respectively. To reflect the trend, an indicator denoted herein as trend factor is calculated by the logarithm value of the ratio of F_{current} to Fₚₐₛₜ.

$${F}_{yrs} = \frac{{\sum }_{yr = i}^{j} {f}_{yrs}}{{\sum }_{yr = i}^{j} {N}_{yrs}} ( if i \neq j ) = \frac{{f}_{i}}{{N}_{i}} ( if i = j ) \qquad ( 4 )$$

$${F}_{past} = 1000 \times \frac{{\sum }_{FIRST}^{LAST} {f}_{yrs}}{{\sum }_{FIRST}^{LAST} {N}_{yrs}} and {F}_{current} = 1000 \times \frac{{\sum }_{FIRST}^{LAST} {f}_{yrs}}{{\sum }_{FIRST}^{LAST} {N}_{yrs}} \qquad ( 5 )$$

$$Trend factor = log ( \frac{{F}_{current}}{{F}_{past}} ) \qquad ( 5 )$$

Plugging in the first and last years for the two periods of time (2000-2009 and 2010-2019) yields the following:

$${F}_{past} = 1000 \times \frac{{\sum }_{2000}^{2009} {f}_{yrs}}{{\sum }_{2000}^{2009} {N}_{yrs}} and {F}_{current} = 1000 \times \frac{{\sum }_{2010}^{2019} {f}_{yrs}}{{\sum }_{2010}^{2019} {N}_{yrs}} \qquad ( 6 )$$

### Conventional Statistical Analysis

A primary assessment includes conventional statistical analysis of temporal and geospatial variations in publications and top frequent keywords. Annual frequency is used to assess temporal variation for both publication and keywords. In general, three groups of keywords (i.e., research topics) are identified and analyzed; namely, Top (most popular), trending up, and emerging, specific information pertaining to these will be described below. When counting papers that have multiple authors, corresponding author information is used to extract geospatial information, based on spaCy, a Python NLP package for NER. When multiple corresponding authors are responsible for a paper, the count is split based on the frequency of their home countries/regions. For example, if a paper had three corresponding authors whose affiliations are in USA, USA, and China, ⅔ and ⅓ are added to USA and China, respectively.

### Keywords Co-Occurrence Analysis

Co-occurrence analysis of keywords helps to reveal knowledge structure of a research field. A co-occurrence means that two keywords are found in the same paper, and a higher co-occurrence (for example, 100) indicates that the two keywords are more frequently used together (in 100 papers) by researchers. This study first assessed the associations among the top 50 frequent keywords, and then expanded the investigation to include more keywords for a more comprehensive assessment on the most popular research topics in the past 20 years. Preprocessed keywords are alphabetically ordered for the same paper to avoid underestimation of frequency. In other words, the co-occurrence analysis is performed only based on elements in the permutation groups rather the sequence (“A & B” is identical to “B & A” where A, B are two keywords). Circos plots may be used to visualize the connections between keywords using Python packages NetworkX and nxviz. NetworkX is used to construct the network data, and nxviz is used to create graph visualizations using data generated from NetworkX

For example, within the context of the illustrative example, the following co-occurrence, association, and distribution tools/analyses may be utilized:

Keywords (research topics), terminologies, authors, institutions, countries/regions, citations/references are analyzed for their respective co-occurrence, association, and distribution.

Co-occurrence analysis: Frequency analysis of co-occurring items (keywords, authors, etc.) in the same article or publication.

Distribution analysis: Analysis of distribution or fraction of co-occurring items (keywords, authors, etc.) in the same article or publication.

Association analysis: Analysis of association among different articles or publications based on the same item (keywords, authors, etc.).

Terminologies preparation. Terminologies are generated based on title, abstract, or full-text by tokenizing n-grams (n=1, 2, 3, 4, etc.). Generated tokens are then converted to lowercase and removed (single) stop-words. Terminology-candidates are first identified based on the original keyword list, and candidates that contained more information are retained when there are multiple similar for each paper.

Author information preparation. Author information by their names are first identified; corresponding information, such as digital object identifier, ORCID, Researcher ID, and Email address, are then used to differentiate different researchers with the same name.

Institutions information preparation. Institution information by their names are first identified; corresponding information, such as physical addresses, ZIP code, are then used to combine the same institution with different (formats of) names.

Countries/regions information preparation. Countries/regions information are first identified based on correspondence information. When counting papers that have multiple authors, corresponding author information is used to extract geospatial information. When multiple corresponding authors are responsible for a paper, the count is split based on the frequency of their home countries/regions.

### (C) Rule-Based Classification Scheme

Returning to the method 200 of FIG. 2, at step 250 the method 200 performs rules-based classification processing of keyword information to identify major/minor domains (topics) of the collection of content items.

While the processing of step 250 is depicted as occurring after the processing of step 240, it is noted that the processing of step 250 is entirely independent from the processing of step 240. In some embodiments, only the processing of step 240 is performed. In some embodiments, only the processing of step 250 is performed. In some embodiments, the processing of each of steps 240 and 250 is performed, and such processing may occur in any sequence (i.e., 240-250 or 250-240), since these each of these steps 240/250 is an independent processing step benefitting from the deep text preprocessing and data preparations steps 220-230 described above.

### Classification Based on Major Domains

LDA-based topic modeling has well-defined procedures, modularity, and extensibility, but it cannot specify group topics in unsupervised learning. Various embodiments as applied to the illustrative example contemplate classifying papers based on five major environmental domains, including air, soil, solid waste, water, and wastewater. As discussed in the results, although this classification scheme eliminates some studies that do not associate with specific domains, this approach makes it possible to recognize interconnections among different topics and how those interconnections are distributed among different environmental domains.

Various embodiments utilize an iterative rule-based classification method based upon domain knowledge. Because one paper (or other content item) can be related to multiple domains, the final classification results are visualized as a membership-based networks using NetworkX. The numbers of papers can vary in different domain-based groups, and major groups with more than 200 papers (whose results are more statistically meaningful) are further analyzed to identify the priority research topics and interactions within each of the major groups.

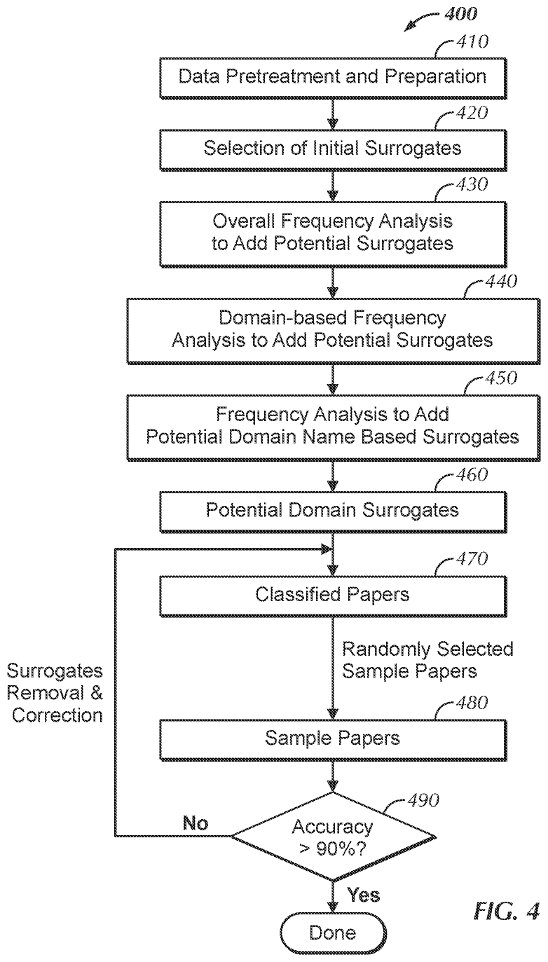

FIG. 4 depicts a flow diagram of an iterative rule-based classification method according to an embodiment. Specifically, the method 400 of FIG. 4 is configured to address the particular keywords and/or dataset components of interest. Within the context of the illustrative example, the following method is used:

At step 410, data pretreatment and preparation are implemented. For example, the title, abstract, and keywords of a paper are treated and combined to develop the corpus; keywords are preprocessed as described previously; the abstract is also tokenized by n-grams (n=1, 2, 3, and 4), lowercased, stop-worded, and stemmed. To accurately classify the papers, specific terms, denoted as domain surrogates, are carefully and rigorously selected to label every individual domain. The selected surrogates should be representative. For example, compared to disinfection, disinfection byproduct is a better surrogate to label a water-specific study. Selection of surrogates followed an iterative procedure comprised of the following steps:

At step 420, a selection of initial or typical surrogates is performed. For example, because the keywords water and air are less representative, more specific and frequent terms that included “water” or “air”, such as drinking water or air quality, are identified for use in the illustrative example.

At step 430, an overall frequency analysis is performed to add potential surrogates. That is, new surrogates are identified from frequent terms of pre-classified papers based on pre-identified surrogates.

At step 440, a domain-based analysis is performed to add potential surrogates.

At step 450, a frequency analysis is performed to add potential surrogates.

At step 460, the potential domain surrogates or set of surrogates is selected and ready for further processing.

At step 470, papers (content items) are processed using the potential domain surrogates, and randomly selected groups of papers (content items), illustratively 50 papers, are verified at step 480 to determine the accuracy of the selected domain surrogates. Steps 470 and 480 are iteratively performed until at step 490 a minimum document retrieval rate (e.g., 80%) is achieved.

Post-hoc validation may be used to improve the classification accuracy. Fifty sample papers are randomly selected for review at each iteration (though more or fewer would suffice), and inappropriate surrogates are removed or corrected afterward. A sample classification accuracy (correct number/sample size) may be calculated and the validation iteratively conducted until 90% accuracy is achieved.

In addition to the newly developed text mining methods described above, independent analyses using library science methods are performed by Princeton University research librarians using the databases obtained from Web of Science and Scopus.

Specifically, in library science, traditional methods for analyzing literature include bibliometric analysis such as those cited in the introduction, systematic reviews which synthesize the results of several similar studies, meta-analysis which uses statistical methods to analyze results of similar studies, and analysis tools provided by databases such as Web of Science. A search in Web of Science for the journal Environmental Science & Technology from 2000-2019 provides analysis of fields such as categories, publication years, document types, authors, organizations, countries of origin, and more. Web of Science's automated analysis has limitations on selecting specific document types, so the analysis includes more documents than are used in this study. Web of Science Categories are included in the analysis instead of keywords. For the journal Environmental Science & Technology only two categories, “Engineering Environment” and “Environmental Studies”, are applied across all articles published between 2000-2019. This analysis is not able to reveal emerging topics or research gaps. Similarly, the Web of Science automated analysis of the publication over time only provides data on the number of articles published as opposed to the analysis of keywords over time performed in this study. Web of Science limits the number of countries analyzed to 25. The numbers are slightly different because of the inability to select specific document types, but the rankings provided by Web of Science match those in this study. Scopus indexing of Environmental Science & Technology for the years 2000-2019 seems to be incomplete. Analysis provided by Scopus for a similar dataset provides the same level of granularity as compared to Web of Science. In Scopus it is possible to view and limit based on keywords but no advanced analysis of keywords is available. In fact the top keyword available in Scopus is “Article” with 16,076 results. It is clear that the text mining approach presented in this study has provided a more in depth understanding of emerging topics and research gaps than searching directly in the database would provide.

Environmental Science & Technology is one journal among a whole ecosystem of interdisciplinary research. In addition to other peer reviewed journals related to the environment, research results are also disseminated through technical reports, government documents such as U.S. Geological Survey sources, and state government agencies. Like the literature cited in the introduction, the analysis on Environmental Science & Technology in this study provides insight into a slice of environmental research. Other text mining studies vary widely in scope and breadth, but few are related to environmental studies. Rabiei et al. used text mining on search queries performed on a database in Iran to analyze search behavior. Other studies examine text mining as a research tool, but using research from another discipline. In a text mining study on 15 million articles comparing the results of using full text versus abstracts, Westgaard et al. found that “text-mining of full text articles consistently outperforms using abstracts only”.

Within the context of the illustrative example, the title, abstract, and keywords of a paper are treated and combined to develop the corpus; keywords are preprocessed and the abstract is also tokenized by n-grams (n=1, 2, 3, and 4), lowercased, stop-worded, and stemmed. To accurately classify the papers, specific terms, denoted as domain surrogates, are carefully and rigorously selected to label every individual domain. The selected surrogates should be representative. The selection of surrogates followed an iterative procedure comprised of the following steps:
1. Initial, typical surrogates are brainstormed and prepared;
2. More specific, frequent terms that included specific domain (or similar concepts) terms are identified;
3. New surrogates are identified from frequent terms of pre-classified papers based on pre-identified surrogates;
4. A manual inspection is used to serve as an additional expansion on the list of surrogates based on unlabeled papers;
5. Steps 3 and 4 are iteratively conducted until a minimum document retrieval rate (e.g., 80%) is achieved and no or only few (e.g., <5) new surrogates are identified.

6. A post-hoc validation is taken to improve the classification accuracy. A number (e.g., 50) of sample papers are randomly selected for review at each iteration, and inappropriate surrogates are removed or corrected afterward. A sample classification accuracy (correct number/sample size) is calculated and the validation is iteratively conducted until an accuracy (e.g., 90%) is achieved.

### (D) Data Visualization Methodology

Returning to the method 200 of FIG. 2, at step 260 the method 200 generates an information product in accordance with the prior steps, such as a customer report including the information derived in the various steps depicted herein.

In various embodiments, a customer request for an information product includes source material identification sufficient to enable automatic retrieval of unstructured content items at step 210 to form a collection suitable for use in satisfying the customer requests, followed by the automatic processing of the collection of unstructured content items in accordance with the remaining steps to provide information sufficient to generate an information report responsive to the customer request.

Optionally the information product may include or comprise various visualizations of keyword trend factors and/or identified major/minor domains (topics) of collection according to various visualization schemes

For example, a log-scaled bubble plot may be used to visualize the trend of the top 1000 frequent keywords using the Python library bokeh. Each bubble, which represents a keyword, may be rendered by a color such as that which is used to differentiate the trend factor. Bubble size may be used to illustrate geospatial popularity or the number of countries/regions that studied the particular topic. 101201 To further analyze the trending up keywords and their specific temporal trends, keywords may be screened based on trend factor (>0.4), F_{current} (>4), and other criteria.

Within the context of the illustrative example, the selection of trending up topics may predicated on the following: 101221 Majority of trending up keywords are determined based on moderate values of the trend factor (>0.4) and F_{current} (>4). The two criteria helped to ensure a general growing popularity in selected keywords when comparing their normalized frequencies during the current period (2010-2019) with the past period (2000-2009). To guarantee a steady popularity, an additional criterion (F₂₀₁₅₋₂₀₁₉/F₂₀₁₀₋₂₀₁₄>90%) is applied to exclude keywords with a much lower frequency in the most recent years. The proposed trending analyzing method simplified the selection processes, but the break point may cause an “edge effect”. In other words, it is possible to miss a potential trending up keywords if its frequency rapidly increases over the years just before 2009 but slowly increases subsequently. Although most of this type of keywords can be still detected using the above approach, some of them have a trend factor of between 0.2 and 0.4, below the defined threshold. To address this issue, two additional criteria are considered to screen the candidates that did not meet the original trend factor (>0.4):

a. The normalized frequency in the current period (2010-2019) should be slightly higher (0.1 <trend factor₂₀₀₇₋₂₀₀₉²⁰¹⁰⁻²⁰¹⁹<0.25 than the normalized frequency during 2007-2009 (years just before 2010); and
b. The normalized frequency in the current period (2010-2019) should be significantly higher (trend factor₂₀₀₀₋₂₀₀₆²⁰¹⁰⁻²⁰¹⁹>0.4) than the normalized frequency during 2000-2006.

It is also noted that the above approaches may help to determine the most trending up topics, while there are many other less popular, trending up topics.

Further, a heat map may be used to show their temporal frequency trend based on annual normalized frequency from 2000 to 2019. A further co-occurrence analysis may also be conducted to reveal interactions among the most trending up topics.

A similar approach may be applied to identify emerging topics but emphasized the most recent five years; the range of the past and current periods are changed to 2000-2014 and 2015-2019, respectively. The emerging topics are screened using a stricter trend factor (>0.6) but a lower F₂₀₁₅₋₂₀₁₉ (>3) with 500 additional low-frequency (total 1500) keywords because emerging topics may not occur at high frequencies. A heat map is subsequently used to exhibit specific temporal trends.

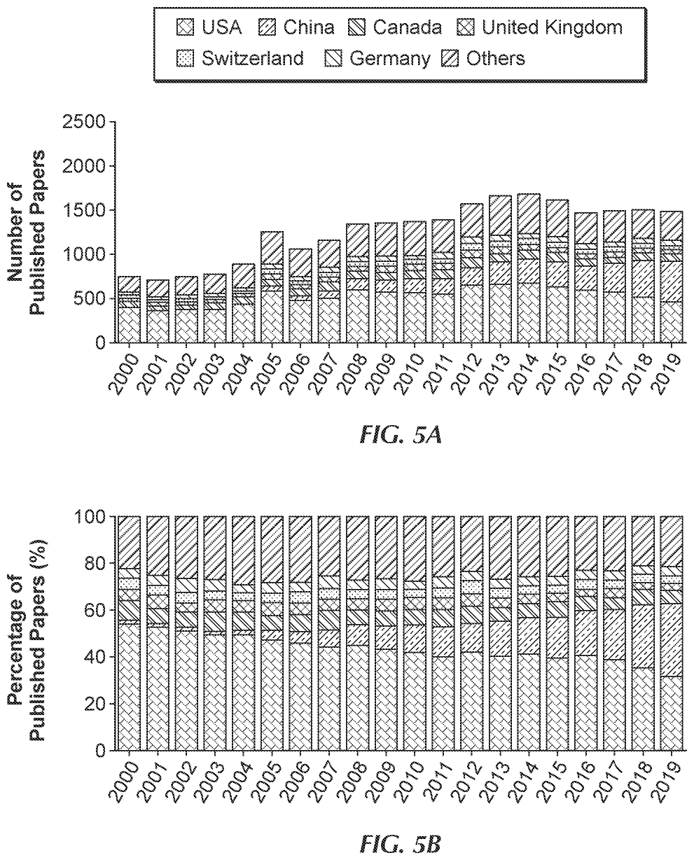

FIGS. 5-18 graphically depict various visualizations in accordance with the embodiments and useful in understanding the results of the exemplary embodiment.

FIG. 5 graphically depicts temporal and geospatial variations of articles and reviews published in ES&T from 2000 to 2019. (a) Actual number of papers; (b) percentage of valid papers.

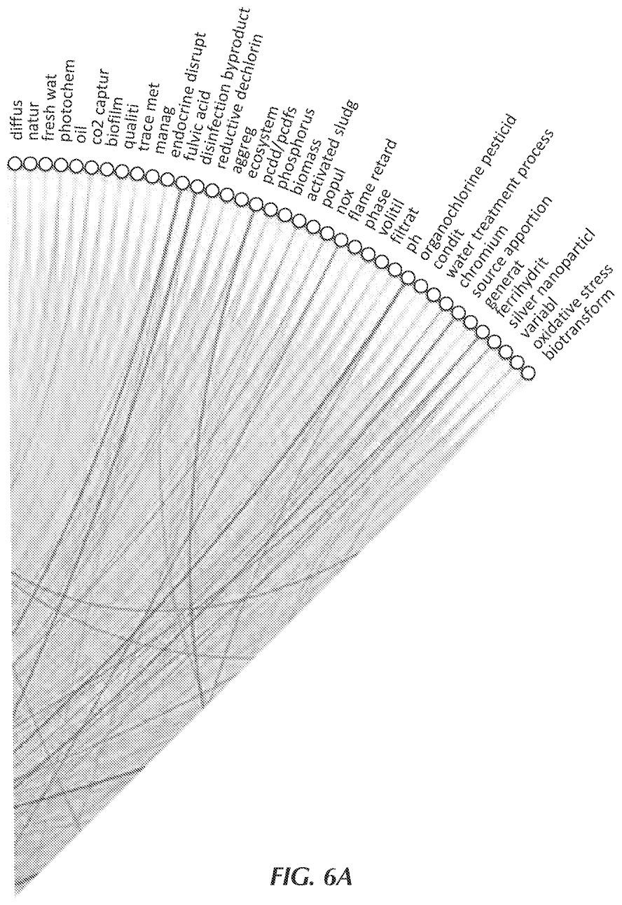

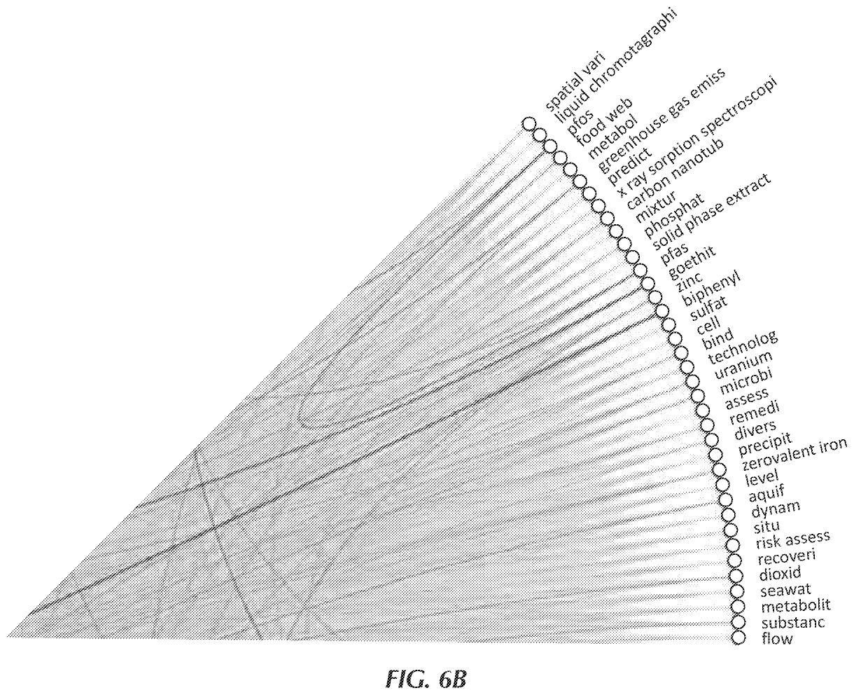

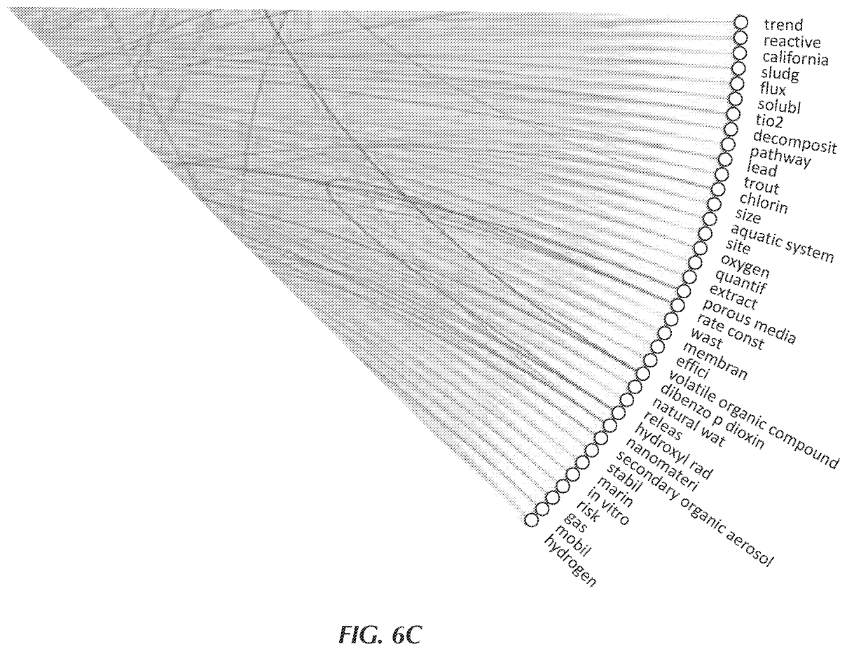

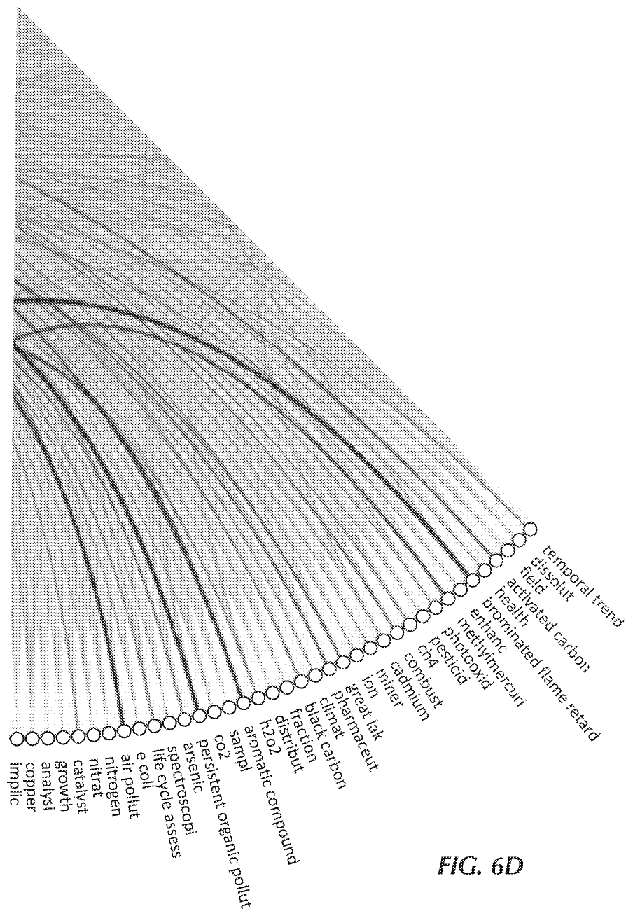

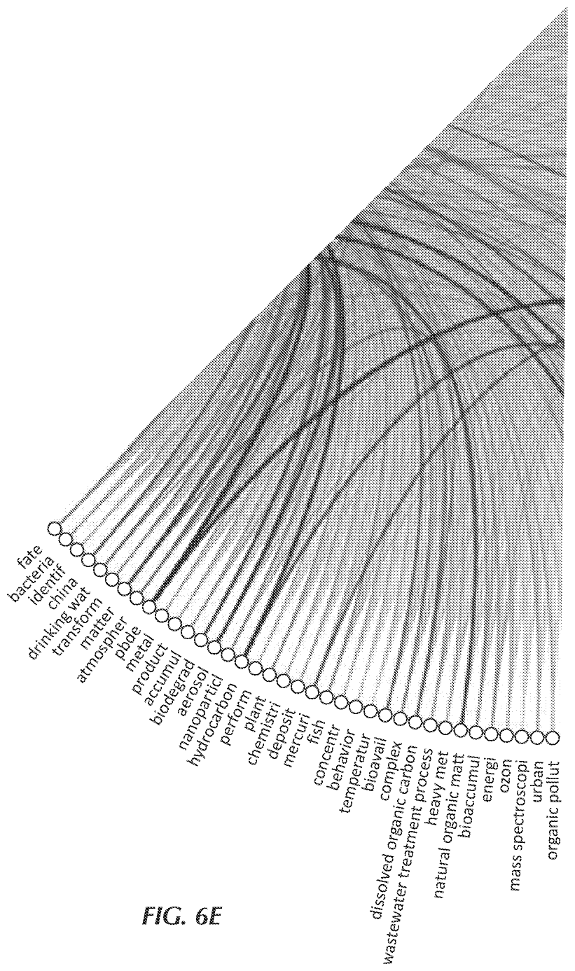

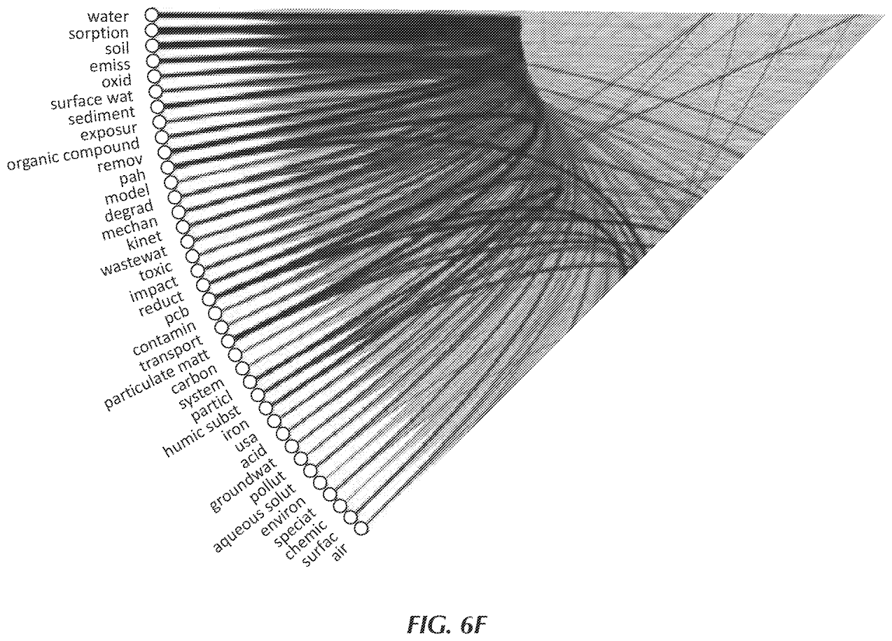

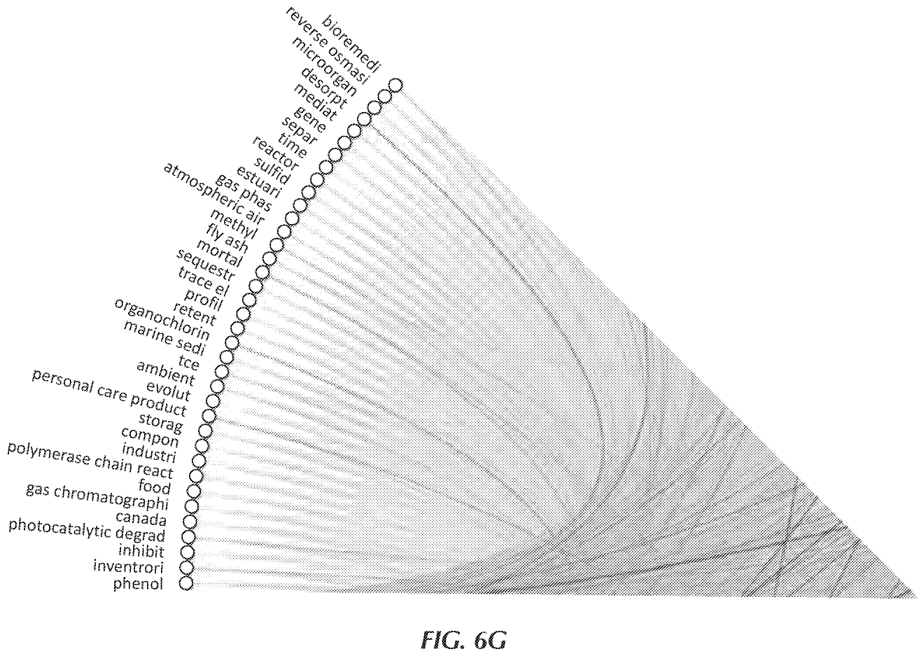

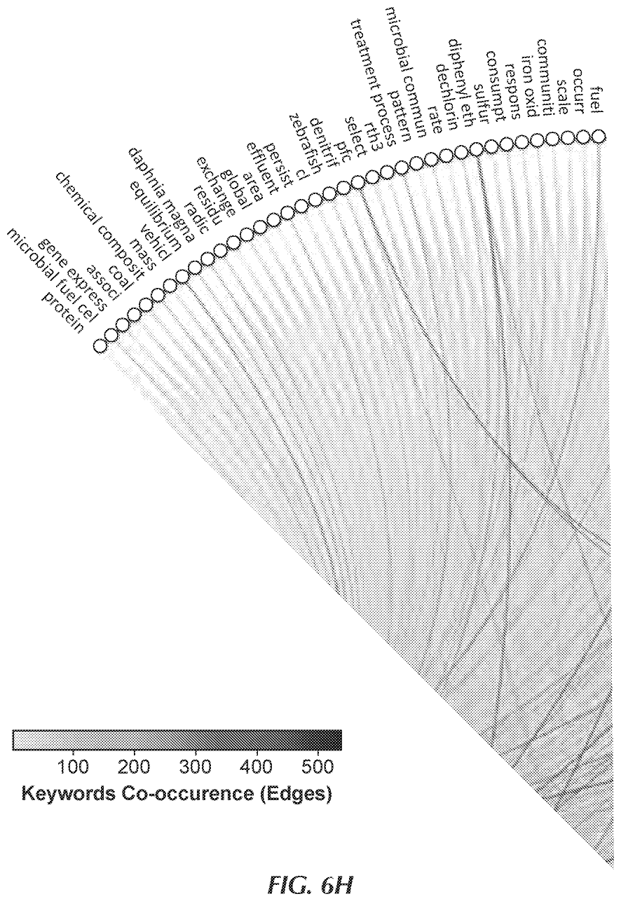

FIG. 6 graphically depicts co-occurrence of the top 300 frequent keywords (stemmed form) based on the circos plot. The keywords (nodes) are ordered by their overall frequency. Edge width and color are used to indicate the co-occurrence between keywords.

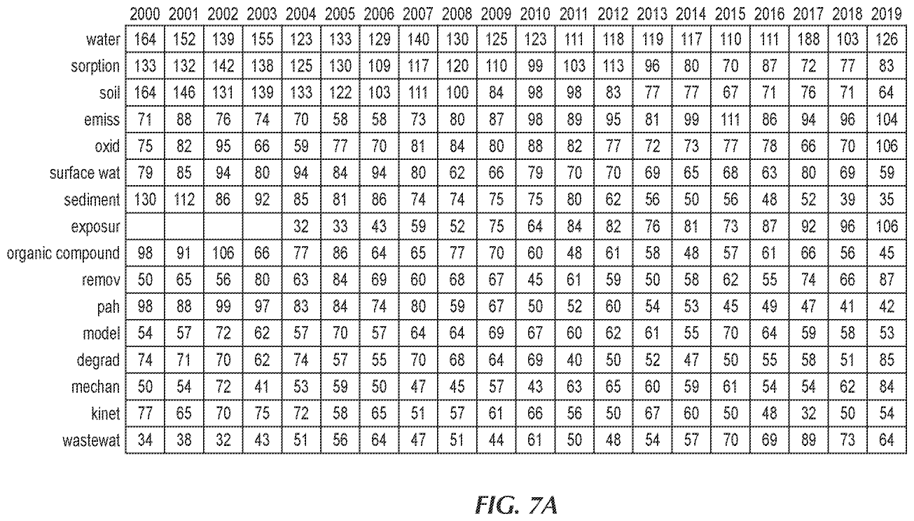

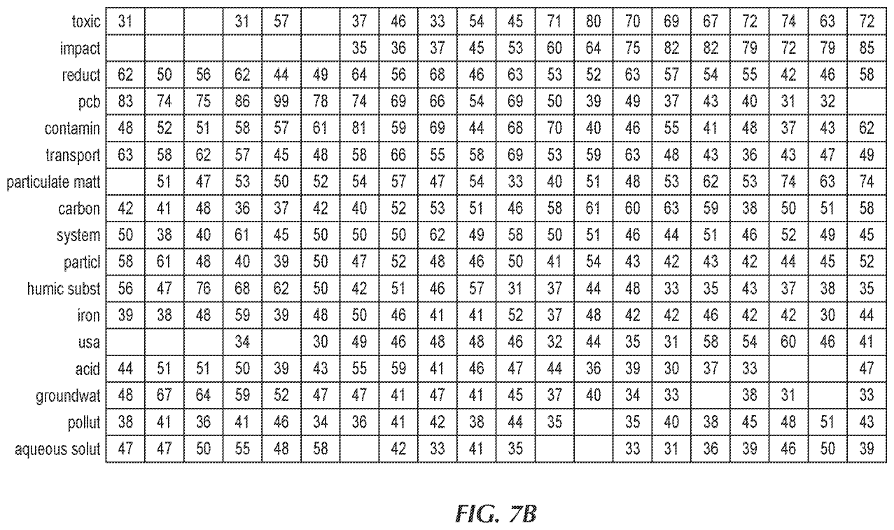

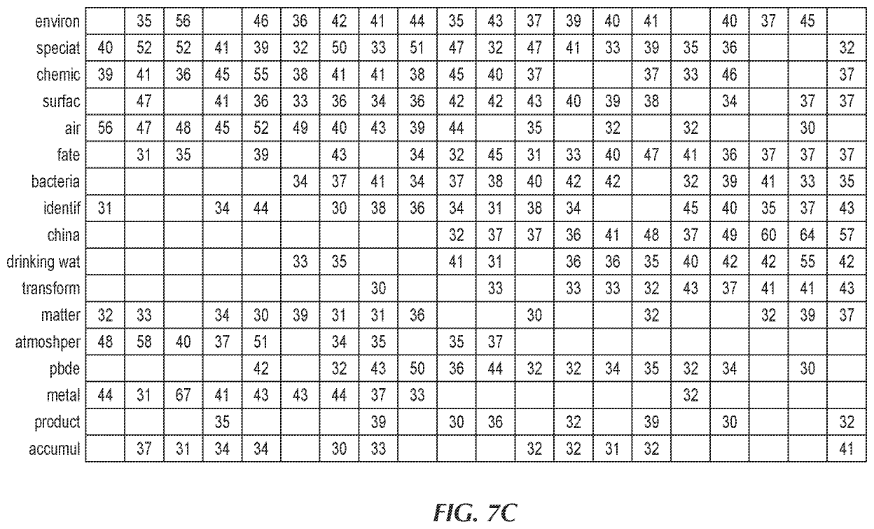

FIG. 7 graphically depicts a temporal trend of the top 50 frequent keywords based on normalized annual frequency. Higher frequencies (≥30) are labeled.

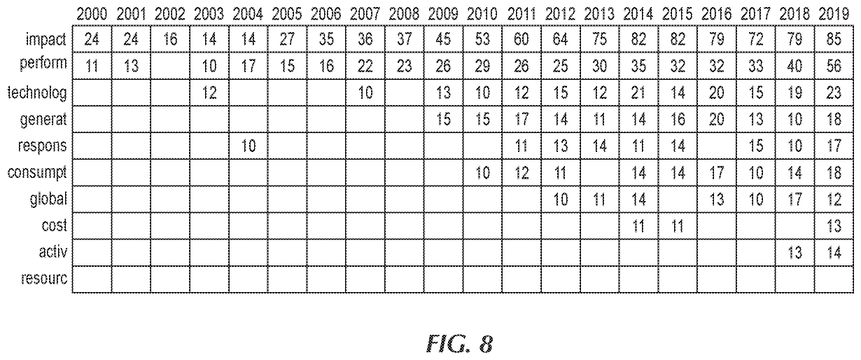

FIG. 8 graphically depicts a temporal trend of ten other “general” keywords that have been trending up over the time based on annual normalized frequency. Higher frequencies (≥10) are labeled; keywords are ordered by the cumulative frequency.

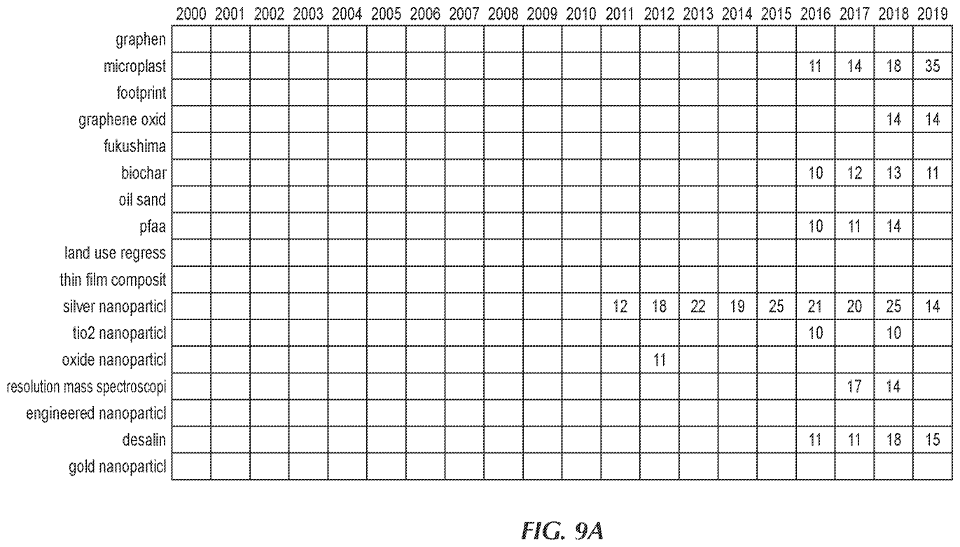

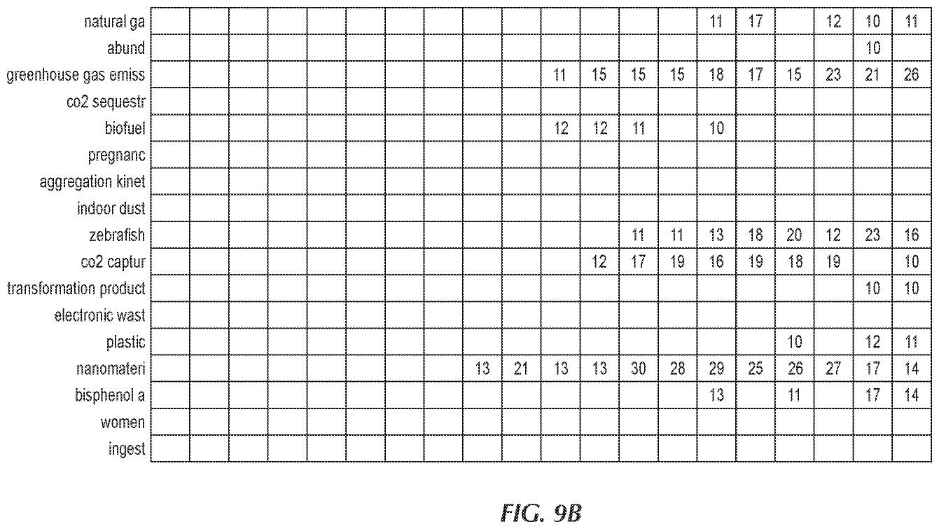

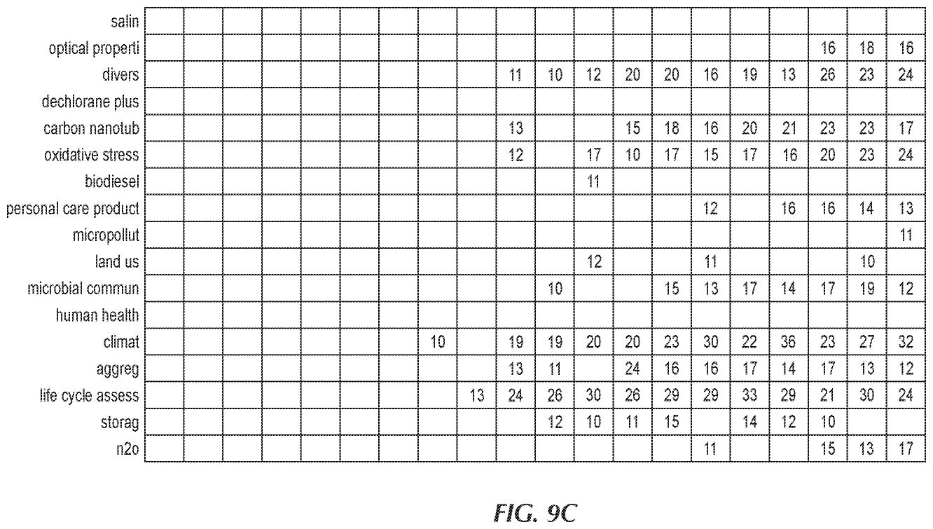

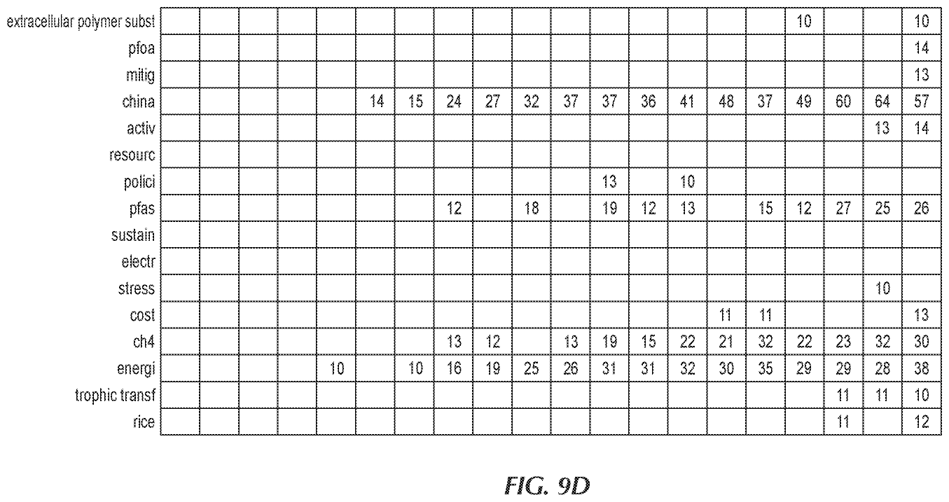

FIG. 9 graphically depicts a temporal trend of keywords that have been trending up over the time based on annual normalized frequency. Higher frequencies (≥10) are labeled; keywords are ordered by the trend factor.

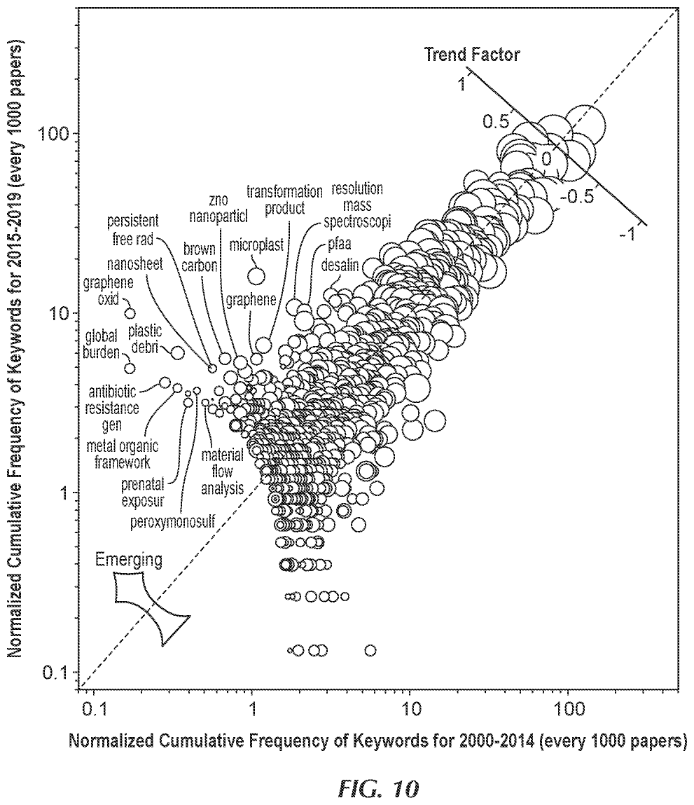

FIG. 10 graphically depicts normalized cumulative frequencies of the top 1500 frequent keywords (bubbles) in the earlier (2000-2014) and most recent (2015-2019) periods. Trend factor value is shown by color; keywords rendered by the red color are more likely to be emerging research topics. The size of bubble reflects the geospatial popularity of the keyword.

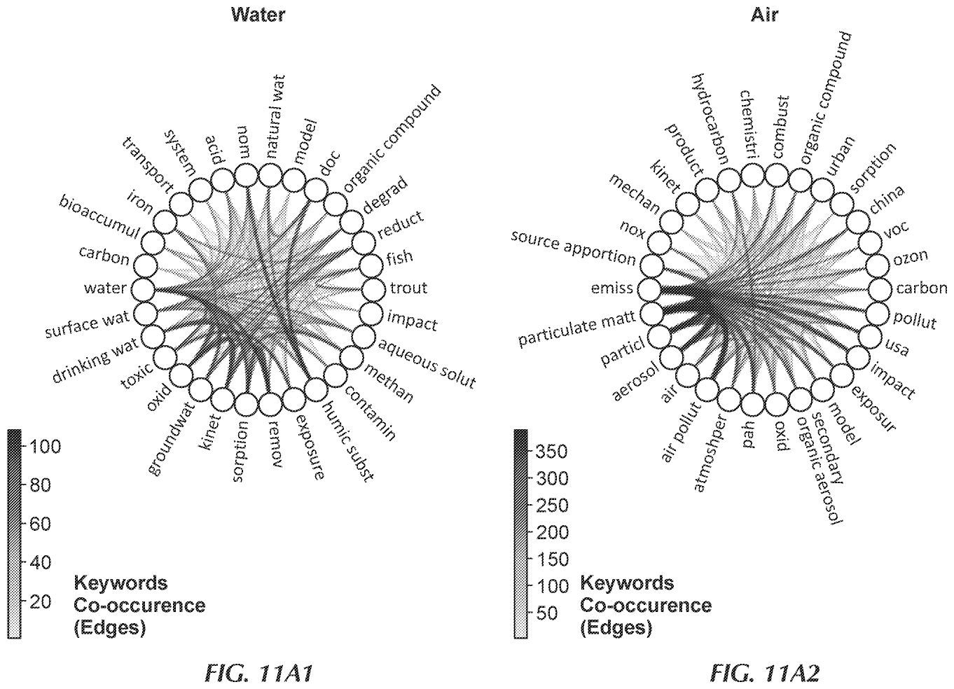

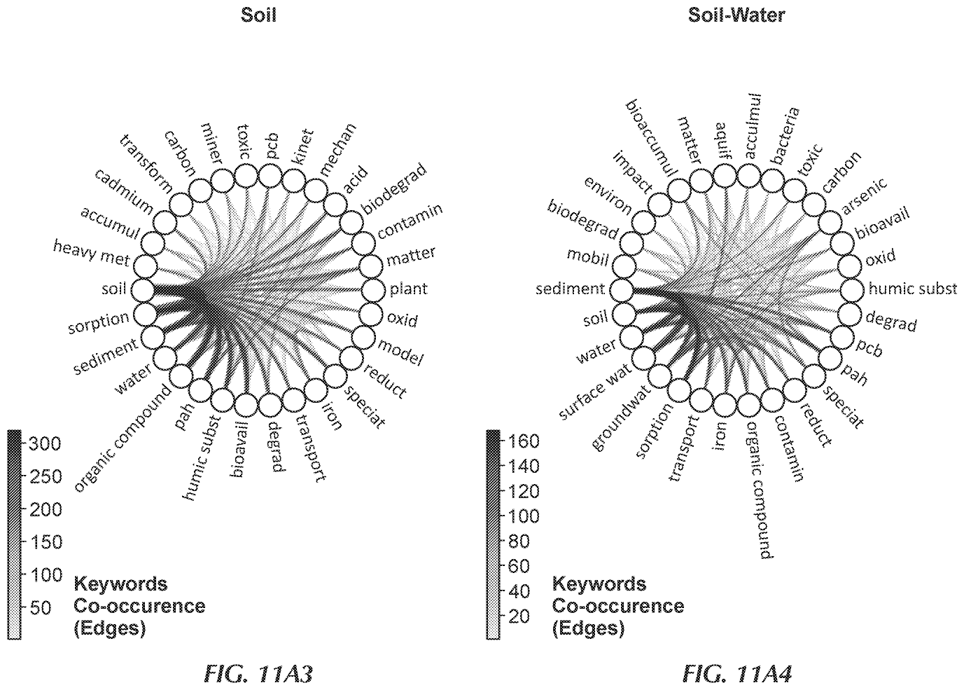

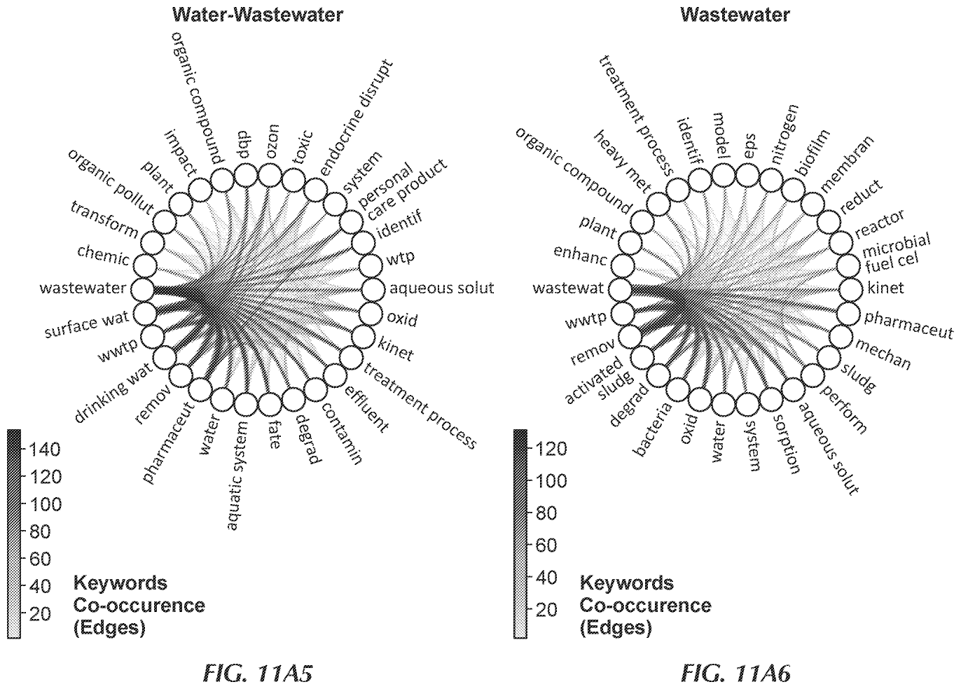

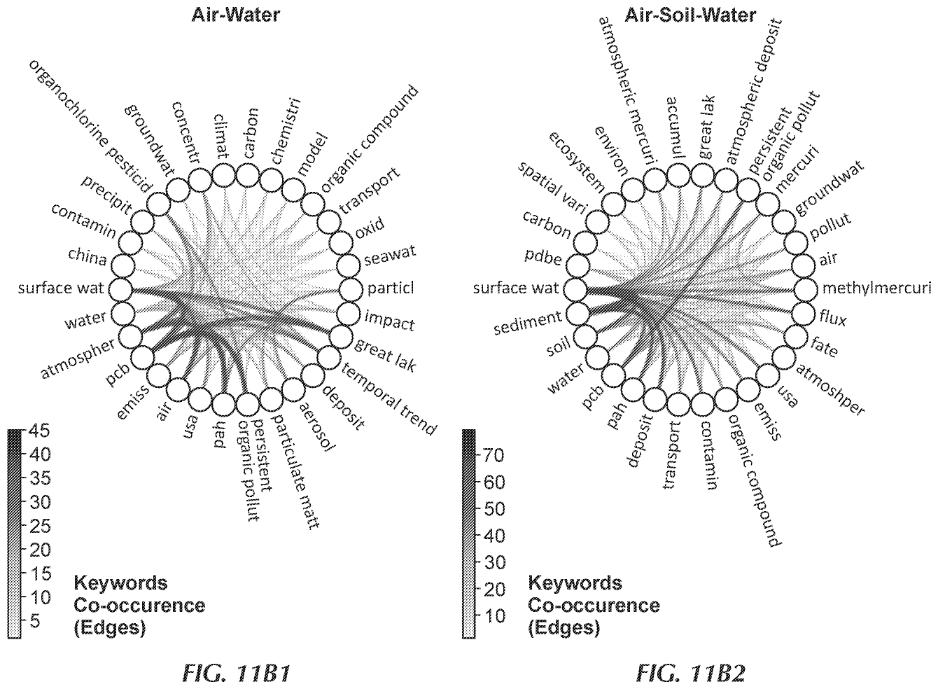

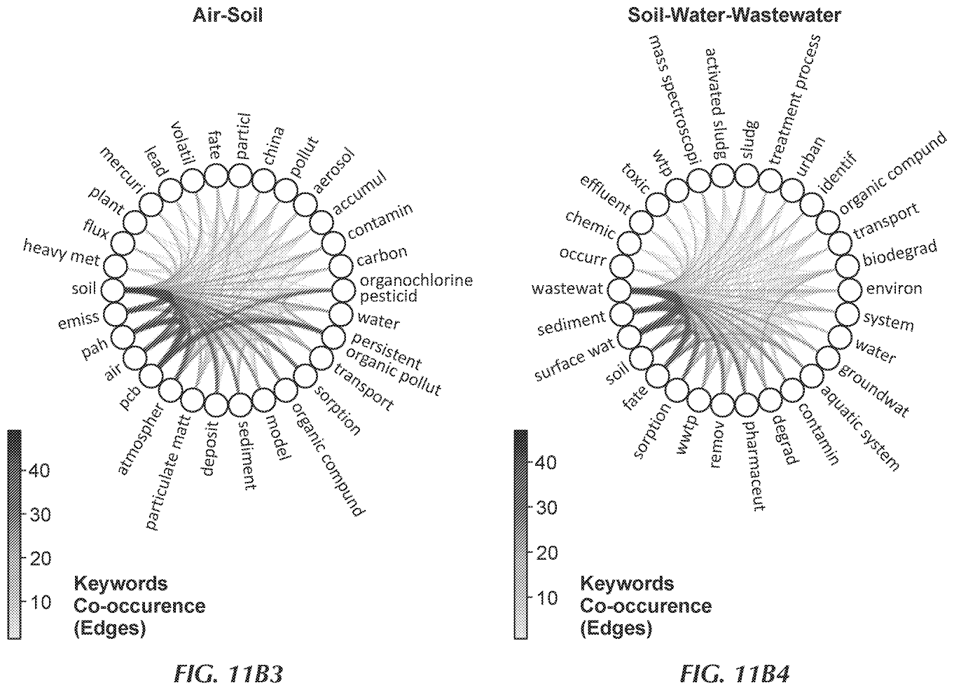

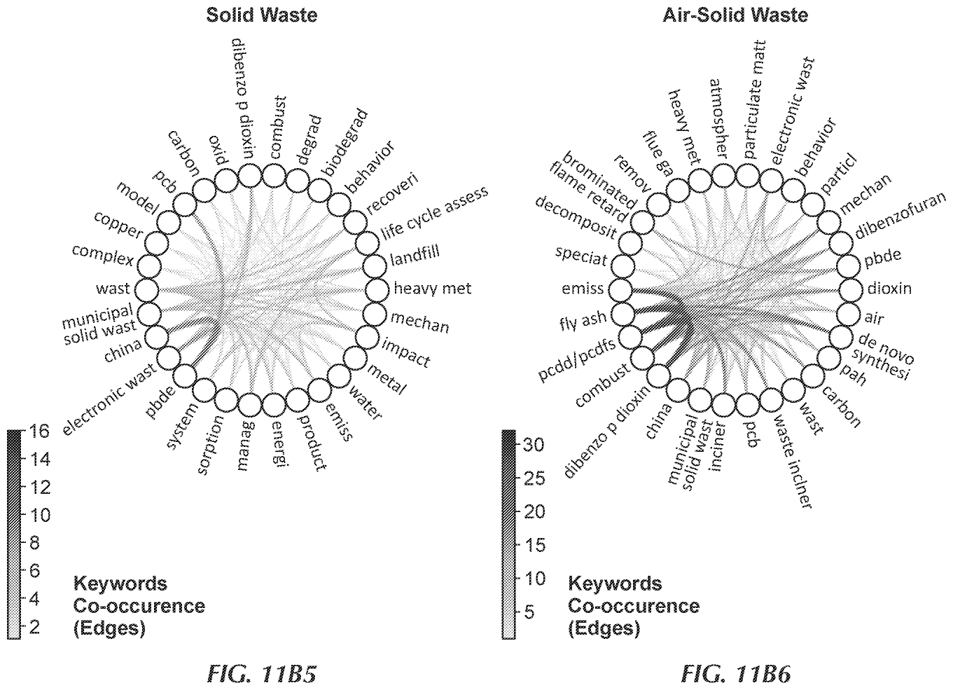

FIGS. 11A-11B graphically depict a co-occurrence of the top 30 frequent keywords (stemmed form) for each of the major 12 groups based on the circos plot. The keywords (nodes) are ordered by their overall frequency. Edge width and color are used to indicate the co-occurrence between keywords.

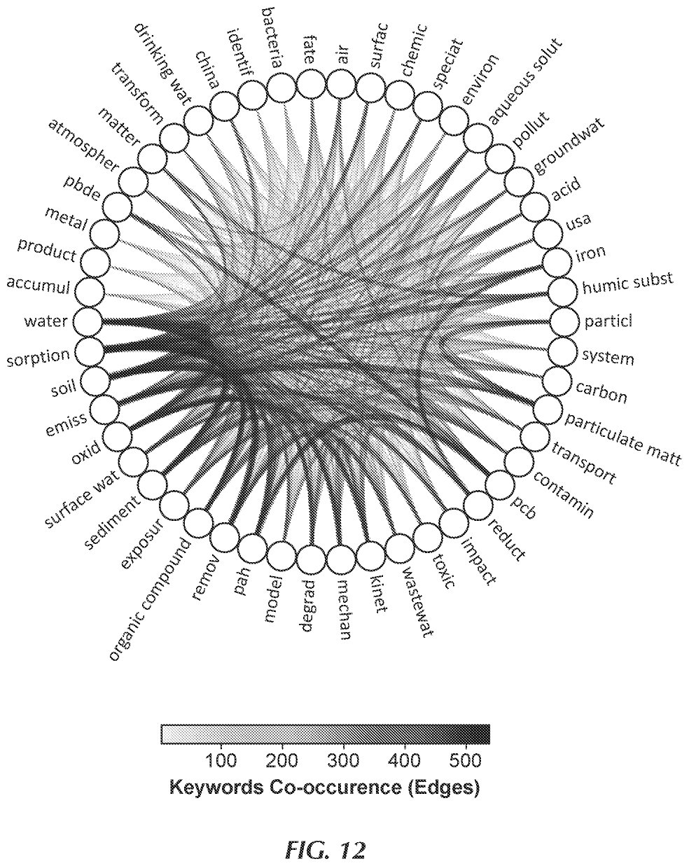

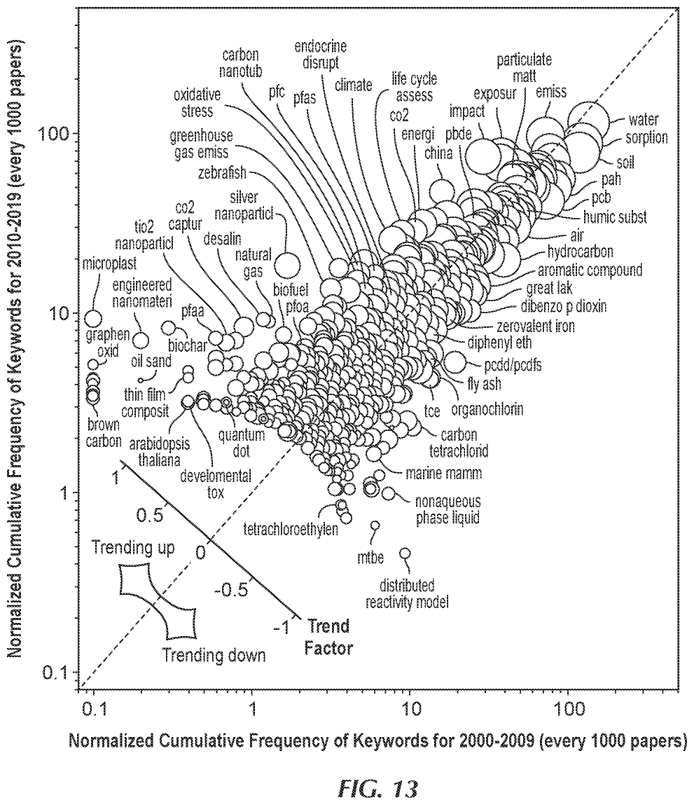

FIG. 12 graphically depicts co-occurrence of the top 50 frequent keywords (stemmed form) based on the circos plot. The keywords (nodes) are ordered by their overall frequencies from dark to light green color. Edge width and color are used to represent the co-occurrence between keywords; a thicker edge with darker color means that the two keywords have a higher co-occurrence.

FIG. 13 graphically depicts distribution of temporal trend of the top 1,000 frequent keywords (bubbles) based on their normalized cumulative frequencies in the past (2000-2009) and recent (2010-2019) decades. Trend factor value is shown by color; keywords rendered by the red and blue colors are more likely to be trending up and trending down, respectively. The size of bubble reflects the geospatial popularity of the keyword.

Specifically, FIG. 13 represents normalized keyword frequency (log scale) on x and y axis, wherein the figure is bisected by a neutral trend line, wherein distance from the trend line indicates increasing trend (more or less popularity in the recent years), the size of the bubble associated with a keyword represents the geospatial popularity of the keyword, the relative darkness or opacity of the bubble represents the incremental value of the respective trend factor.

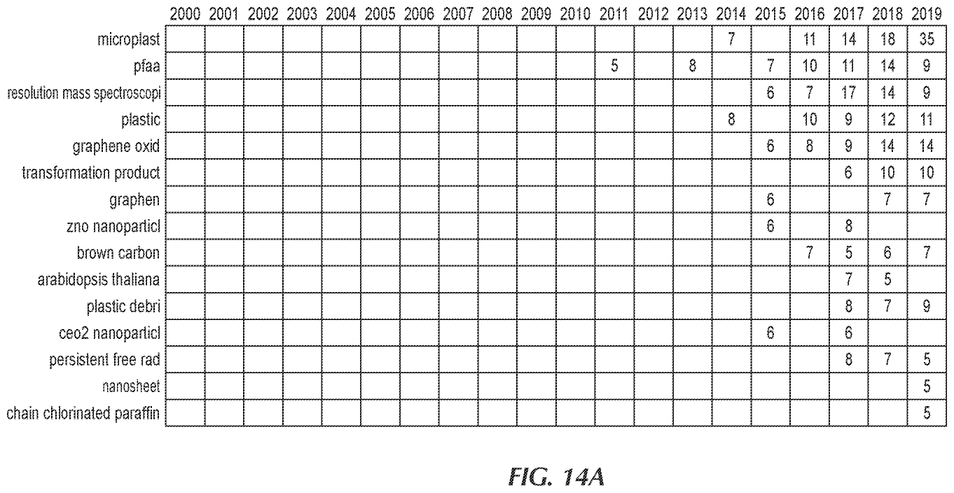

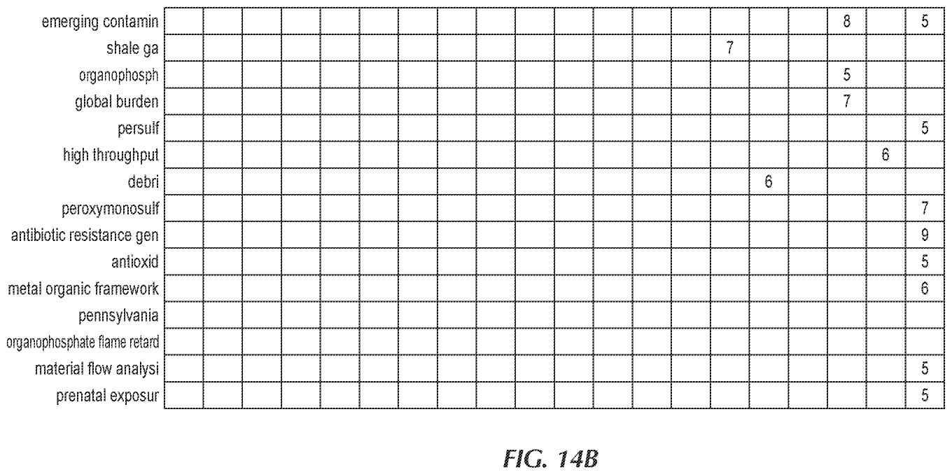

FIG. 14 graphically depicts an example of a heat map plot that demonstrates order and ranking among the most trending up, specific keywords of selections over the past 20 years based on annual normalized frequency. Keywords are ordered by the cumulative frequency, and any normalized frequencies above ten are labeled.

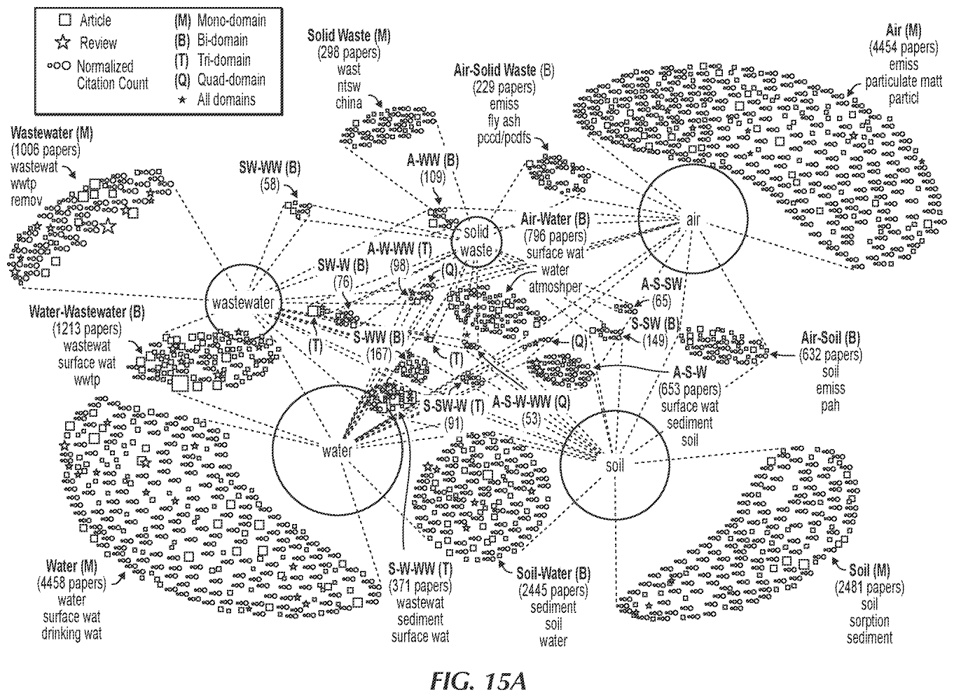

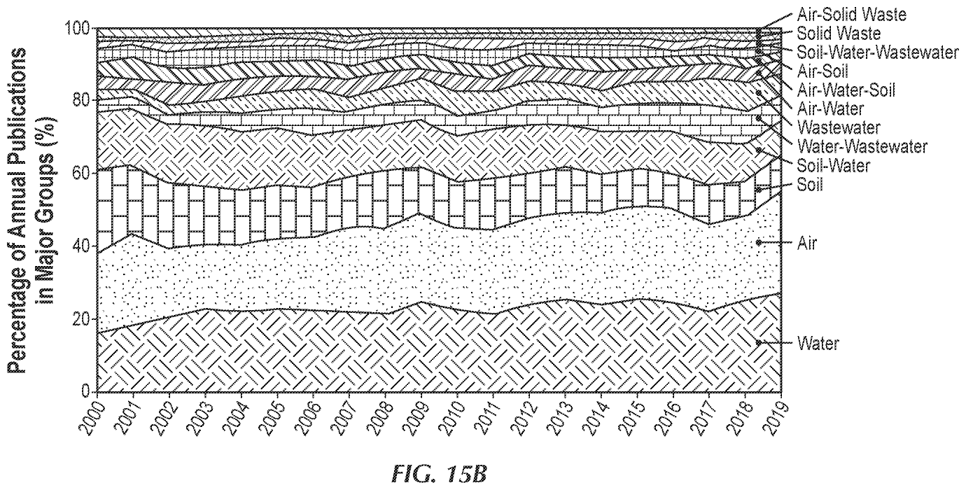

FIG. 15 graphically depicts the Membership-based network of publications (n=20,067) distributed in the 31 domain-based groups. Size of the big orange circle reflects the number of associated papers from the five domains (A: air; S: soil; SW: solid waste; W: water; WW: wastewater); different colors of mark and edge show different groups of publications and their connections, respectively; bigger size and lower transparency of a mark means that the paper has a higher normalized citation count. Groups with 50 or more papers are labeled by group name and number of papers (and the top 3 keywords for the 12 major groups). It also shows the temporal variation in percentage distribution of annual publications based on the 12 major groups.

Specifically, FIG. 15 is a constellation network plot or visualization representing relationships among data points (studies) in predefined domains (i.e., each of the constellations represents the study), and the connections represent the interrelationships between domains. Each constellations represents a respective study (i.e., research paper in the context of the example), the shape of the constellation represents whether the paper is as research paper (circle shape) or a review paper (star shape), and the size of the constellation represents a normalized citation count associated with the paper, color represents different domains and corresponding domain to domain connections between constellations (papers). The size of the domain represents the number of relevant papers (i.e., papers including information that pertain to the particular technical or topical information associated with the domain/topic)

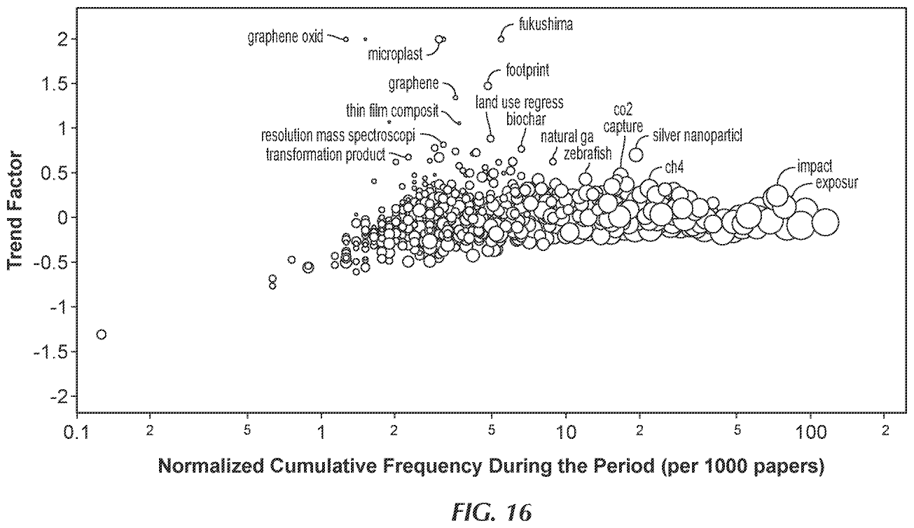

FIG. 16 graphically depicts a 2D illustration of 3D example of galaxy diagram that demonstrates the evolution of trend factor and frequency overtime. Keywords with orange color are more likely to be trending up. The size of bubble reflects the geospatial popularity of the keyword.

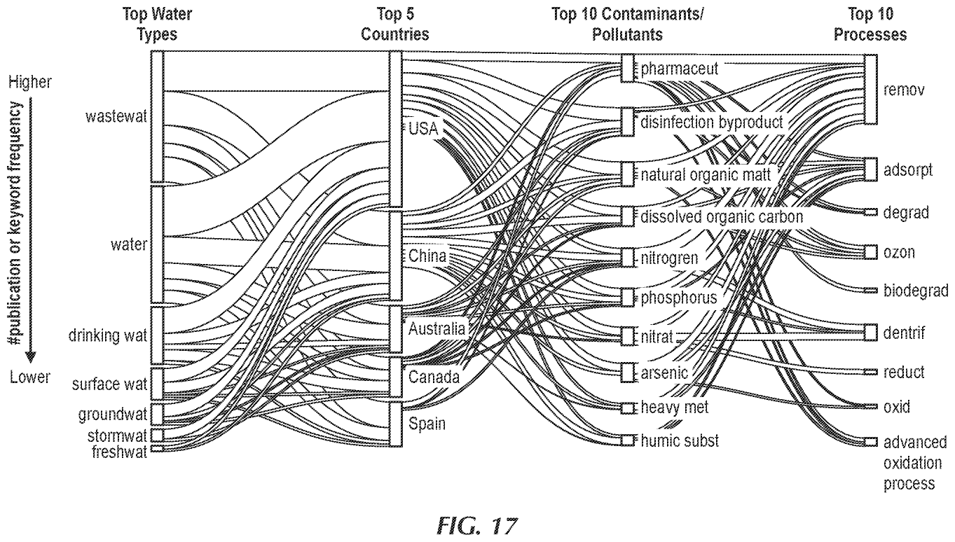

FIG. 17 graphically depicts an example of Sankey diagram that demonstrates the interconnections among different categories of user defined keywords. The colors differentiate different groups under the same category, and the thickness of the connection flows stands for the frequencies of co-occurrence between the two terms.

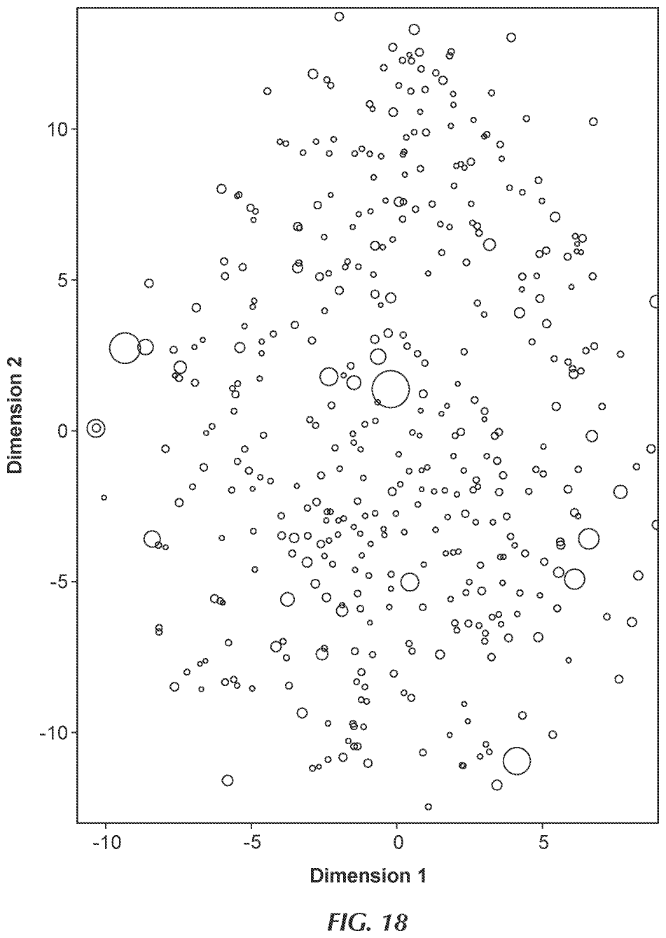

FIG. 18 graphically depicts an example of Word2vec-based (word embedding) t-SNE plot that shows the distribution of keywords in a vector space where the distance between them stands for their similarities and interconnections. The size of bubbles shows the normalized frequency and colors indicates the trend factor.

### (E) Online Information Gathering, Processing, Broadcasting Tool

Returning to the method 200 of FIG. 2, at optional step 270 the method 200 augments keyword trend factors and/or identified major/minor domain (topics) of collection in accordance with customer requirements, privacy requirements, and/or other requirements to provide actionable output reporting.

As previously noted with respect to FIGS. 1-2, a tool may be used to collect the most recent publication information from journals or publishers (an exemplary online information gathering, processing, and broadcasting tool is depicted in the appended Figure). The tool uses data from Web of Science, PubMed's API, Elsevier's Scopus, and RSS or employs web crawlers to gather XML (or relevant) information of updated publications from journal or publisher websites. By using one or more of the aforementioned methods, information is preprocessed and prepared for further broadcasting.

The disclosed methods and programs may be optimized to enable most customized information collection and processing, and to further increase the accuracy. Further optimization will be based on additional analyses of different journals or publication types, to increase the scope and flexibility of the information gathering and processing.

The disclosed approach may be employed as part of a tool or product (e.g., an App, website, RSS service, and so on) such as for use by researchers, publishers, investors, and institutions to receive timely updates on the trending research topics and progress, without often biased inputs by humans, so they can know what is going on and make better decision.

TABLE S1
Eleven major challenges identified in raw keyword data and
their corresponding six-step preprocessing approaches.

| Challenges | | Corresponding preprocessing approaches (with |
|---|---|---|
| Description | Examples | inspection applied to all) |
| Same stem but in | system vs. systems (system); | Standard word stemming. All keywords are |
| different forms | contamination vs. | lowercased and keywords with more than four |
| | contaminants (contamin) | letters are stemmed before other steps. Python |
| | | NLP package nltk and the “SnowballStemmer” |
| | | algorithm is used. For example, contamination |
| | | and contaminants are both normalized to their |
| | | root contamin. A few words with irregular |
| | | plural forms are manually corrected, such as |
| | | bacterium (bacteria), consortium (consortia), |
| | | and medium (media). |
| Prefix or isomer | 3,3′-dichlorobiphenyl vs. | Excess component removal. ChemListem, a |
| | dichlorobiphenyl; alpha | deep neural networks-based Python NLP |
| | alumina vs. alumina | package for chemical named entity recognition |
| | | (NER), is adopted to pre-select organic |
| Excess ending word | lead concentration vs. lead; | chemicals to avoid affecting terms like 16s |
| | copper ion vs. copper | ribosomal-rna and 25-degrees-c. A rule is |
| | | applied to typical isomers (such as 1,1,1- |
| | | trichloroethan or 2,2′,4,4′-tetrabromodiphenyl |
| | | ether) that contain number, hyphen, and more |
| | | than three letters while the first element must be |
| | | number, and number and letters are not |
| | | successive. Prefix like alpha, beta, and gamma |
| | | are removed, initial words such as |
| | | contaminated, environmental, and polluted and |
| | | ending words such as atom, concentration(s), |
| | | emission(s), formation, ion(s), level(s), |
| | | production, reduction, and removal, are |
| | | eliminated for all non-single-word keywords. |
| Acronyms and | PAH vs. polycyclic aromatic | Acronym identification and replacement. A |
| abbreviations | hydrocarbon; DBP vs. | text-based method is used to detect initial |
| | disinfection byproduct | letters-based acronyms. The primary step to |
| | | identify X-letter acronyms (X = 2, 3, 4, or 5) is |
| | | to screen all X-letter candidates with defined |
| | | stop words, such as air and gas (X = 3). |
| | | Candidates are further selected while each of |
| | | them should have corresponding, first-letters- |
| | | matched X-word term(s). Corresponding articles |
| | | are identified and reviewed to determine the |
| | | final acronyms based on domain knowledge. An |
| | | acronym is a combination of initial letters (e.g., |
| | | PAH) or partial-initial letters (e.g., TCE) of a |
| | | terminology, typically from three to five letters. |
| | | The same method without the first-letters- |
| | | matched step is used to detect the partial initial |
| | | letters-based acronyms. |
| | | Table S2 lists 45 acronyms identified in this |
| | | study with special case explained. |
| Different chemical | carbon dioxide vs. CO₂; Hg | Chemical recognition and unification. |
| expressions | vs. mercury | Inorganic chemicals had different expressions |
| | | (name or formula) in the raw data. Identifying |
| | | chemical formula using Chemical NER |
| | | (ChemListem) is determined not effective in this |
| | | case, instead detecting chemical name is used to |
| Chemicals with charges | mercury(ii) versus Hg(ii) | screen chemicals (e.g., use carbon dioxide |
| or roman numerals | versus Hg²⁺ | rather than co2) with relatively high frequency. |
| | | In 377 frequent chemicals, only 22 of them are |
| | | required to be unified (Table S3). Words that |
| | | contain any typical formats of roman numerals |
| | | (e.g., i, . . . , vii, (i), . . . , (vii)) or charges (+, |
| | | 2+, . . . , 7+) are identified and replaced |
| | | correspondingly (Table S4). Specifically, |
| | | different formats (e.g., chromium(iii), cr(iii), |
| | | chromium(vi), cr(vi), and cr) of a metal are |
| | | unified to a single, base name (chromium) only |
| | | except when the metal (e.g., iron) has different |
| | | names in different valences (ferrous oxide or |
| | | ferric oxide) and is not the single element in the |
| | | chemical. |
| Similar terms that may | organic compound and | Principal term detection and combination. |
| be combined | organic chemical are | The method involves detecting the same first |
| | combined, whereas organic | (several) word(s), which are denoted them as |
| | contaminant and organic | “principal terms”. Any frequent keywords had |
| | compound are not | the same principal terms (only the last word |
| Subset terms that may | in situ bioremediation and in | varies) are identified if they have the same |
| be combined | situ remediation are | number of words. For example, acid rain and |
| | combined | acid deposition or dissolved humic substance |
| | | and dissolved humic material are combined, |
| | | respectively. The method is applied to keywords |
| | | from one- to four-word, leading to 62 groups of |
| | | synonyms based on domain knowledge (Table |
| | | S5). A similar method is applied to the |
| | | keywords with the same last (several) word(s), |
| | | such as carbon nanotube and walled carbon |
| | | nanotube, leading to another 56 groups of |
| | | synonyms (Table S6). |
| Terms that have the | sewage water vs. | Inspection and post-hoc correction. In each of |
| same meaning | wastewater; physical | the above five steps, an initial inspection is used |
| | chemical vs. | to prepare an effective preprocessing method, |
| | physicochemical | and a final inspection is taken to determine and |
| | | combine variants and synonyms. In addition, a |

| Other miscellaneous challenges include excess | post-hoc inspection and correction is conducted |
|---|---|
| parenthesis (e.g. poly(dimethylsiloxane) vs. | to refine the final treated keywords database and |
| polydimethylsiloxane), excess hyphen (waste-water vs. | improve the reliability of results. This post-hoc |
| wastewater), irregular space (zero valent iron vs. | step helped to address many issues, such as |
| zerovalent iron), and repeat-word acronym | same-meaning terms, subset terms, and other |
| (trinitrotoluene tnt) | miscellaneous issues. |
| All keywords are capitalized in the raw data which | Solved with other issues by the above |
| makes the above issues more challenging | approaches. For example, use chemical name |
| | rather than chemical formula in the chemical |
| | NER; acronym is not identified based on capital |
| | letters. |

### Supplemental Information (Tables)

TABLE S2
Acronyms identified (frequency ≥5) and their full descriptions
(punctuations removed and remain as singular form).

| Acronym | Full description | Acronym | Full description |
|---|---|---|---|
| AFM | Atomic force microscopy | PCB | Polychlorinated biphenyl |
| AHTN | Acetyl hexamethyl tetralin | PCDD* | Polychlorinated dibenzodioxin |
| BHT | Butylated hydroxytoluene | PCDF* | Polychlorinated dibenzofuran |
| BPA | Bivalve potamocorbula amurensis | PCE | Perchloroethylene |
| DDT | Dichlorodiphenyltrichloroethane | PCN | Polychlorinated naphthalene |
| DOC | Dissolved organic carbon | PCR | Polymerase chain reaction |
| DOM | Dissolved organic matter | PFAS** | Perfluorinated alkylated substance |
| EPS | Extracellular polymeric substance | PFC | Per/poly fluorinated compound |
| GAC | Granular activated carbon | PFOA | Perfluorooctanoic acid |
| GC | Gas chromatography | PFOS | Perfluorooctane sulfonate |
| GIS | Geographic information system | PM | Particulate matter |
| HBCD | Hexabromocyclododecane | RDX | Hexahydro trinitro triazine |
| HCH | Hexachlorocyclohexane | RO | Reverse osmosis |
| LCA | Life cycle assessment | SCR | Selective catalytic reduction |
| MBR | Membrane bioreactor | SMP | Soluble microbial product |
| MEA | Monoethanolamine | SOA | Secondary organic aerosol |
| NAPL | Nonaqueous phase liquids | TCDD | Tetrachlorodibenzo p dioxin |
| NDMA | N nitrosodimethylamine | TCE | Trichloroethylene |
| NF | Nanofiltration | THM | Trihalomethanes |
| NMR | Nuclear magnetic resonance | TNT | Trinitrotoluene |
| NOM | Natural organic matter | UV | Ultraviolet |
| PAH | Polycyclic aromatic hydrocarbon | VOC | Volatile organic compound |

*PCDD and PCDF are equal frequently studied together, so all the relevant keywords are replaced and combined as pcdd/pcdfs.
**PFAS: Perfluorinated alkylated substance; polyfluorinated alkylated substance; perfluoroalkyl substance; or polyfluoroalkyl substance

TABLE S3
Chemical names that are identified using ChemListem (combined
frequency ≥10) and unified with their formulas.

| Chemical | Chemical | Chemical | Chemical |
|---|---|---|---|
| name | formula | name | formula |
| Ammonia | NH₃ | Nitrate radical | NO₃ |
| Bromide | Br | Nitric oxide | NO |
| Carbon dioxide | CO₂ | Nitrogen dioxide | NO₂ |
| Carbon monoxide | CO | Nitrogen oxide | NOₓ |
| Cerium oxide | CeO₂ | Nitrous oxide | N₂O |
| Cesium | Cs | Palladium | Pd |
| Chloride | Cl | Rhodium | Rh |
| Hydrogen peroxide | H₂O₂ | Selenium | Se |
| Hydrogen sulfide | H₂S | Sulfur dioxide | SO₂ |
| Hydroxyl radical | OH radical | Titanium dioxide | TiO₂ |
| Methane | CH₄ | Zinc oxide | ZnO |

TABLE S4
Identified metals (combined frequency ≥10) that had different forms (in
raw, low-cased texts and separated by semicolons) and their unified forms.

| Different forms | Unified form |
|---|---|
| al; al(iii) | aluminum |
| sb; sb(iii) | antimony |
| as; as(iii); as(v); arsenic(iii); arsenic(v) | arsenic |
| cd; cd(ii); cd 2+; cadmium(ii) | cadmium |
| cr; cr(iii); cr(vi); chromium(iii); chromium(vi); hexavalent chromium | chromium |
| eu; eu(iii); europium(iii) | europium |
| au; au iii; gold(iii) | gold |
| pb; pb(ii); lead(ii) | lead |
| mn; mn(ii); mn(iii); mn(iv); manganese(ii); manganese(iii); manganese(iv) | manganese |
| hg; hg(ii); hg ii; hg2+; mercury(ii); inorganic mercury; elemental mercury | mercury |
| np(v); neptunium(v) | neptunium |
| ni; ni(ii) | nickel |
| pu; pu(iv); pu(v); plutonium(iv) | plutonium |
| ag; ag i | silver |
| tc; tc(vii) | technetium |
| u(iv); u(vi); u vi; uranium(iv); uranium(vi) | uranium |
| zn; zn(ii); zinc(ii) | zinc |
| fe; fe(ii); fe(iii); iron(iii); fe ii; iron(ii); ferrous iron; ferric iron | iron |
| fe(ii); fe ii; iron(ii); ferrous iron | ferrous* |
| fe(iii); iron(iii); ferric iron | ferric* |
| cu; cu(ii); cu ii; cu2+; copper(ii) | copper |
| cu(ii); cu ii; cu2+; copper(ii) | cupric* |

*Only converted to this form if it is part of a binary chemical form, such as fe(ii) oxide

TABLE S5
Keywords (frequency ≥10) the same first (several) word(s) identified based on the
principal term method and their final replaced term (bold). Keywords may be listed as
their singular forms while the actual text replacement also included their plural forms

| No | Keywords |
|---|---|
| 1 | acid deposition; acid rain |
| 2 | advanced oxidation; advanced oxidation process |
| 3 | aerobic biodegradation; aerobic biotransformation |
| 4 | anaerobic biodegradation; anaerobic degradation; anaerobic digestion |
| 5 | aquatic ecosystem; aquatic environment; aquatic system |
| 6 | aromatic compound; aromatic hydrocarbon |
| 7 | atmospheric oxidation; atmospheric photooxidation |
| 8 | chemical analysis; chemical characteristics; chemical characterization |
| 9 | chlorophyll; chlorophyll a; chlorophyll alpha |
| 10 | climate; climate change |
| 11 | competitive adsorption; competitive sorption |
| 12 | contaminated aquifer; contaminated groundwater |
| 13 | cryptosporidium; cryptosporidium parvum; cryptosporidium parvum oocysts |
| 14 | dissolution kinetic; dissolution rate |
| 15 | dissolved humic material; dissolved humic substance; humic substance |
| 16 | dissolved organic compound; dissolved organic carbon |
| 17 | endocrine disrupting compound; endocrine disrupting chemical; endocrine disruption; |
| | endocrine disruptor |
| 18 | energy; energy consumption; energy use |
| 19 | environmental contaminant; environmental pollutant |
| 20 | fecal contamination; fecal pollution |
| 21 | fluidized bed; fluidized bed reactor |
| 22 | food chain; food web |
| 23 | green alga; green algae |
| 24 | greenhouse gas; greenhouse gas emission |
| 25 | geographic information system; geographical information system |
| 26 | human serum; human serum albumin |
| 27 | in situ bioremediation; in situ degradation; in situ hybridization; in situ remediation |
| 28 | ion exchange; ion exchange membrane |
| 29 | land application; land use; land use change |
| 30 | life cycle; life cycle analysis; life cycle assessment |
| 31 | marine; marine environment; marine ecosystem; marine water |
| 32 | messenger RNA; messenger RNA expression |
| 33 | microbial degradation; microbial oxidation; microbial transformation |
| 34 | mytilus edulis; mytilus edulis 1. |
| 35 | nano; nanoscale; nanosized |
| 36 | nanofiltration; nanofiltration membrane; NF membrane |
| 37 | organic acid; organic carbon; organic chemical; |
| 38 | organic compound; organic material; organic matter |
| 39 | organic contaminant; organic micropollutant; organic pollution |
| 40 | organochlorine; organochlorine compound; organochlorine contaminant |
| 41 | PCB; PCB congener |
| 42 | perfluoroalkyl; perfluoroalkyl compound; perfluoroalkyl contaminant; |
| | perfluoroalkyl substance; polyfluoroalkyl chemical; polyfluorinated alkyl substance; |
| | polyfluoroalkyl compound; polyfluoroalkyl substance; PFAS |
| 43 | petroleum; petroleum hydrocarbon |
| 44 | photocatalytic activity; photocatalytic degradation; photocatalytic oxidation |
| 45 | photochemical oxidation; photochemical transformation |
| 46 | photo fenton; photo fenton reaction |
| 47 | quantitative analysis; quantitative determination |
| 48 | reduced sulfur; reduced sulfur groups |
| 49 | rate coefficient; rate constant |
| 50 | RO; RO membrane; reverse osmosis; reverse osmosis membrane |
| 51 | seasonal trend; seasonal variation |
| 52 | solid phase microextraction; solid phase extraction |
| 53 | spatial distribution; spatial pattern; spatial trend; spatial variability; spatial variation |
| 54 | spectroscopic characterization; spectroscopic evidence; spectroscopic properties |
| 55 | steroid estrogens; steroid hormones |
| 56 | surface chemistry; surface properties |
| 57 | temporal trend; temporal variability |
| 58 | thermal decomposition; thermal degradation |
| 59 | treatment process; treatment system; treatment work |
| 60 | ultrafiltration; ultrafiltration membrane; UF membrane |
| 61 | UV; UV light |
| 62 | volatile organic compound; volatile organic contaminant |

TABLE S6
Keywords (frequency ≥10) with the same last (several) word(s) identified based on the
principal term method and their final replaced term (bold). Keywords may be listed as
their singular forms while the actual text replacement also included their plural forms

| No. | Keywords | No. | Keywords |
|---|---|---|---|
| 1 | activated carbon; granular activated carbon | 26 | children; preschool children; young children |
| 2 | aerosol; ambient aerosol; atmospheric | 27 | China; north China; south China |
| | aerosol | | |
| 3 | algae; blue green algae; green algae | 28 | coated silver nanoparticle; silver nanoparticle |
| 4 | alkane; n-alkane | 29 | desalination; seawater desalination; water |
| | | | desalination |
| 5 | ambient air; atmospheric air; outdoor air | 30 | dolphins tursiops truncatus; tursiops |
| | | | truncatus |
| 6 | anaerobic bacteria; strictly anaerobic | 31 | estuary; river estuary |
| | bacteria | | |
| 7 | Asia; east Asia | 32 | exposure; human exposure |
| 8 | Atlantic; north Atlantic | 33 | ferrihydrite; line ferrihydrite |
| 9 | Atlantic salmon; salmon | 34 | fish; marine fish |
| 10 | bears ursus maritimus; ursus maritimus | 35 | groundwater; shallow groundwater |
| 11 | biodiversity; diversity; microbial diversity | 36 | gulls larus argentatus; larus argentatus |
| 12 | biofilm reactor; membrane biofilm reactor | 37 | health; human health |
| 13 | biofilm; microbial biofilm | 38 | in vitro; vitro |
| 14 | biofuel cell; fuel cell; microbial fuel cell | 39 | in vivo; vivo |
| 15 | biomass; microbial biomass | 40 | *Lake Michigan; southern Lake Michigan |
| 16 | black carbon; environmental black carbon | 41 | m-xylene; p-xylene; xylene |
| 17 | blue mussel; mussel | 42 | minnow pimephales promelas; pimephales |
| | | | promelas |
| 18 | California; southern California | 43 | municipal wastewater; wastewater |
| 19 | carbon sequestration; CO₂ sequestration | 44 | nanomaterial; engineered nanomaterial |
| 20 | carp cyprinus carpio; cyprinus carpio | 45 | nanoparticle; engineered nanoparticle |
| 21 | capture; carbon capture; dioxide capture; | 46 | nitrosamine; n-nitrosamine |
| | CO₂ capture | | |
| 22 | chain PFAA; PFAA | 47 | nonylphenol; p-nonylphenol |
| 23 | chain PFCA; PFCA | 48 | northern Sweden; Sweden |
| 24 | chemical ion; ion | 49 | Ontario; southern Ontario |
| 25 | chemistry; environmental chemistry | 50 | temporal trend; time trend |

| | |
|---|---|
| 51 | airborne particulate matter; ambient particulate matter; atmospheric particulate matter; particulate |
| | matter |
| 52 | carbon nanotube; multiwalled carbon nanotube; walled carbon nanotube |
| 53 | liquid chromatography; performance liquid chromatography |
| 54 | magnetic resonance spectroscopy; nuclear magnetic resonance spectroscopy |
| 55 | midwestern USA; northeastern USA; southeastern USA; USA; western USA |
| 56 | rainbow trout; trout; trout oncorhynchus mykiss; oncorhynchus mykiss; salvelinus namaycush; trout |
| | salvelinus namaycush |

*Lake Erie, Lake Michigan, Lake Ontario, and Lake Superior are combined with “great lakes”

TABLE S7
Top 100 frequent keywords (lowercased,
stemmed form) and their frequencies.

| No. | Keyword | Freq |
|---|---|---|
| 1 | water | 3106 |
| 2 | sorption | 2581 |
| 3 | soil | 2383 |
| 4 | emiss | 2187 |
| 5 | oxid | 1969 |
| 6 | surface wat | 1852 |
| 7 | sediment | 1704 |
| 8 | exposur | 1703 |
| 9 | organic compound | 1639 |
| 10 | remov | 1587 |
| 11 | pah | 1560 |
| 12 | model | 1560 |
| 13 | degrad | 1503 |
| 14 | mechan | 1449 |
| 15 | kinet | 1447 |
| 16 | wastewat | 1438 |
| 17 | toxic | 1417 |
| 18 | impact | 1414 |
| 19 | reduct | 1384 |
| 20 | pcb | 1374 |
| 21 | contamin | 1368 |
| 22 | transport | 1351 |
| 23 | particulate matt | 1335 |
| 24 | carbon | 1288 |
| 25 | system | 1253 |
| 26 | particl | 1180 |
| 27 | humic subst | 1127 |
| 28 | iron | 1094 |
| 29 | usa | 1052 |
| 30 | acid | 1039 |
| 31 | groundwat | 1019 |
| 32 | pollut | 1012 |
| 33 | aqueous solut | 980 |
| 34 | environ | 968 |
| 35 | speciat | 960 |
| 36 | chemic | 925 |
| 37 | surfac | 916 |
| 38 | air | 912 |
| 39 | fate | 901 |
| 40 | bacteria | 888 |
| 41 | identif | 871 |
| 42 | china | 871 |
| 43 | drinking wat | 848 |
| 44 | transform | 809 |
| 45 | matter | 790 |
| 46 | atmospher | 787 |
| 47 | metal | 784 |
| 48 | pbde | 784 |
| 49 | product | 752 |
| 50 | accumul | 745 |
| 51 | biodegrad | 732 |
| 52 | aerosol | 711 |
| 53 | hydrocarbon | 698 |
| 54 | perform | 690 |
| 55 | plant | 682 |
| 56 | chemistri | 663 |
| 57 | deposit | 648 |
| 58 | mercuri | 646 |
| 59 | fish | 646 |
| 60 | concentr | 643 |
| 61 | behavior | 636 |
| 62 | nanoparticl | 635 |
| 63 | temperatur | 632 |
| 64 | bioavail | 628 |
| 65 | complex | 626 |
| 66 | dissolved organic | 616 |
| | carbon | |
| 67 | wastewater treatment | 607 |
| | process | |
| 68 | heavy met | 604 |
| 69 | natural organic matt | 603 |
| 70 | bioaccumul | 598 |
| 71 | energi | 592 |
| 72 | ozon | 590 |
| 73 | mass spectroscopi | 569 |
| 74 | urban | 555 |
| 75 | organic pollut | 553 |
| 76 | implic | 553 |
| 77 | copper | 551 |
| 78 | analysi | 550 |
| 79 | growth | 543 |
| 80 | catalyst | 534 |
| 81 | nitrat | 529 |
| 82 | nitrogen | 529 |
| 83 | air pollut | 528 |
| 84 | e coli | 527 |
| 85 | life cycle assess | 511 |
| 86 | spectroscopi | 510 |
| 87 | arsenic | 509 |
| 88 | persistent organic | 508 |
| | pollut | |
| 89 | co2 | 490 |
| 90 | sampl | 486 |
| 91 | aromatic compound | 480 |
| 92 | h2o2 | 475 |
| 93 | distribut | 474 |
| 94 | fraction | 465 |
| 95 | black carbon | 465 |
| 96 | climat | 464 |
| 97 | pharmaceut | 461 |
| 98 | great lak | 456 |
| 99 | ion | 455 |
| 100 | miner | 449 |

TABLE S8
Summary of annual top ten keywords from 2000 to 2019

| Top# | 2000 | 2001 | 2002 | 2003 | 2004 |
|---|---|---|---|---|---|
| 1 | soil | water | sorption | water | soil |
| 2 | water | soil | water | soil | sorption |
| 3 | sorption | sorption | soil | sorption | water |
| 4 | sediment | sediment | organic compound | pah | pcb |
| 5 | organic compound | organic compound | pah | sediment | surface wat |
| 6 | pah | emiss | oxid | pcb | sediment |
| 7 | pcb | pah | surface wat | surface wat | pah |
| 8 | surface wat | surface wat | sediment | remov | organic compound |
| 9 | kinet | oxid | humic subst | kinet | degrad |
| 10 | oxid | pcb | emiss | emiss | kinet |

| Top# | 2005 | 2006 | 2007 | 2008 | 2009 |
|---|---|---|---|---|---|
| 1 | water | water | water | water | water |
| 2 | sorption | sorption | sorption | sorption | sorption |
| 3 | soil | soil | soil | soil | emiss |
| 4 | pah | surface wat | oxid | oxid | soil |
| 5 | organic compound | sediment | surface wat | emiss | oxid |
| 6 | surface wat | contamin | pah | organic compound | sediment |
| 7 | sediment | pcb | sediment | sediment | exposur |
| 8 | pcb | pah | emiss | contamin | organic compound |
| 9 | oxid | oxid | degrad | reduct | model |
| 10 | model | remov | contamin | degrad | remov |

| Top# | 2010 | 2011 | 2012 | 2013 | 2014 |
|---|---|---|---|---|---|
| 1 | water | water | water | water | water |
| 2 | sorption | sorption | sorption | sorption | emiss |
| 3 | soil | soil | emiss | emiss | impact |
| 4 | emiss | emiss | soil | soil | exposur |
| 5 | oxid | exposur | exposur | exposur | sorption |
| 6 | surface wat | oxid | toxic | impact | soil |
| 7 | sediment | sediment | oxid | oxid | oxid |
| 8 | degrad | toxic | surface wat | toxic | toxic |
| 9 | transport | surface wat | mechan | surface wat | surface wat |
| 10 | pcb | contamin | impact | kinet | carbon |

| Top# | 2015 | 2016 | 2017 | 2018 | 2019 |
|---|---|---|---|---|---|
| 1 | emiss | water | water | water | water |
| 2 | water | sorption | emiss | emiss | exposur |
| 3 | impact | exposur | exposur | exposur | oxid |
| 4 | oxid | emiss | wastewat | impact | emiss |
| 5 | exposur | impact | surface wat | sorption | remov |
| 6 | wastewat | oxid | soil | wastewat | impact |
| 7 | sorption | soil | particulate matt | soil | degrad |
| 8 | model | toxic | toxic | oxid | mechan |
| 9 | surface wat | wastewat | remov | surface wat | sorption |
| 10 | soil | model | impact | remov | particulate matt |

TABLE S9
Summary of the 79 couples of high frequent
(≥200) co-occurring keywords

| Keyword 1 | Keyword 2 | Freq. |
|---|---|---|
| sorption | soil | 538 |
| water | sorption | 467 |
| emiss | particulate matt | 434 |
| sorption | remov | 426 |
| pcb | pah | 409 |
| soil | sediment | 369 |
| pcb | pbde | 345 |
| particl | particulate matt | 342 |
| pbde | brominated flame retard | 334 |
| soil | organic compound | 325 |
| pah | hydrocarbon | 321 |
| pcb | persistent organic pollut | 317 |
| sorption | oxid | 315 |
| oxid | mechan | 312 |
| reduct | iron | 312 |
| water | soil | 309 |
| impact | emiss | 308 |
| water | remov | 307 |
| sorption | organic compound | 306 |
| oxid | kinet | 305 |
| sorption | sediment | 303 |
| water | sediment | 303 |
| air pollut | particulate matt | 300 |
| surface wat | sediment | 298 |
| sediment | pah | 298 |
| water | oxid | 296 |
| sorption | humic subst | 292 |
| oxid | degrad | 288 |
| mechan | kinet | 287 |
| aerosol | particulate matt | 286 |
| remov | oxid | 284 |
| reduct | oxid | 282 |
| soil | pah | 281 |
| oxid | iron | 280 |
| humic subst | natural organic matt | 278 |
| wastewat | remov | 276 |
| hydrocarbon | aromatic compound | 274 |
| surfac | sorption | 270 |
| matter | humic subst | 266 |
| toxic | exposur | 266 |
| degrad | biodegrad | 259 |
| water | degrad | 254 |
| pah | aromatic compound | 250 |
| sorption | mechan | 249 |
| mercuri | methylmercuri | 247 |
| water | organic compound | 238 |
| usa | emiss | 237 |
| pah | organic compound | 236 |
| sorption | iron | 232 |
| particl | emiss | 224 |
| sorption | reduct | 223 |
| sorption | pah | 222 |
| wastewat | surface wat | 222 |
| sorption | aqueous solut | 221 |
| water | aqueous solut | 220 |
| sorption | kinet | 219 |
| speciat | soil | 219 |
| sediment | pcb | 218 |
| water | kinet | 218 |
| water | acid | 217 |
| water | groundwat | 217 |
| pcb | biphenyl | 217 |
| emiss | china | 214 |
| kinet | degrad | 214 |
| humic subst | dissolved organic carbon | 213 |
| soil | humic subst | 213 |
| soil | degrad | 212 |
| sorption | activated carbon | 211 |
| humic subst | acid | 209 |
| pcb | contamin | 208 |
| water | contamin | 207 |
| speciat | sorption | 205 |
| soil | bioavail | 205 |
| particl | aerosol | 203 |
| sediment | organic compound | 203 |
| transport | soil | 203 |
| reduct | kinet | 202 |
| water | mechan | 202 |
| remov | reduct | 201 |

TABLE S10
Major domain surrogates (#influenced documents ≥5) identified during the rule-based classification
method based on ES&T data. Different forms or abbreviations of surrogates might be used.

| Domain | Domain surrogates |
|---|---|
| Air | acid deposition; acid rain; aerosol; air emission; air mass; air pollution; air quality; air |
| | sample; airborne; ambient air; atmospheric; co2 capture; co2 emission; clean air; coal fired |
| | power plant; downwind; dry deposition; dust sample; emission control; emission factor; |
| | emission inventory; emission rate; emission reduction; emissions inventory; emissions |
| | reduction; exhaust; flue gas; fly ash; fossil fuel combustion; indoor; light duty vehicle; long |
| | range transport; marine boundary layer; meteorological; multimedia model; nitrogen dioxide |
| | emission; nitrogen oxide emission; nitrous oxide emission; particulate matter; plume model; |
| | reactive gaseous; semivolatile organic compound; smog; source apportionment; sulfur |
| | dioxide; ultrafine particle; vehicle emission; volatile organic compound; water vapor |
| Soil | acid volatile sulfide; clay; contaminated land; contaminated sediment; contaminated site; |
| | contaminated soil; enrichment factor; glacier; multimedia model; peat; plant root; plant |
| | uptake; porewater; porous heterogeneous medium; remobilization; rhizosphere; root cell; |
| | sediment; sedimentary; snowpack; soil; subsurface; superfund |
| Solid waste | agricultural waste; animal waste; bottom ash; composting; electronic waste; food waste; |
| | hazardous waste; landfill; livestock waste; mine waste; mining waste; municipal solid waste; |
| | nuclear waste; organic waste; plastic waste; solid waste; waste incinerator; waste |
| | management; waste material; waste pcb; waste repository; wastes disposal |
| Water | acid mine drainage; aquaculture; aquatic ecosystem; aquatic environment; aquatic life; |
| | aquatic organism; aquatic system; aquatic toxicity; aqueous stream; brackish water; coastal |
| | water; contaminated water; creek; cryptosporidium; deepwater; deionized water; |
| | desalination; disinfection byproduct; drinking water; estuary; eutrophication; flood; |
| | freshwater; groundwater; gulf of mexico; hydrology; injection well; irrigation water; lagoon; |
| | lake; marine environment; marine food web; marine mammal; marine water; multimedia |
| | model; mussel; natural water; phytoplankton; polluted water; potable water; rainwater; |
| | receiving water; river; riverine; sea; seawater; softening; source water; stormwater; surface |
| | water; tap water; trout; water act; water consumption; water disinfection; water dispersion; |
| | water distribution; water environment; water footprint; water management; water pollution; |
| | water purification; water resource; water sample; water source; water supply; water |
| | suspension; water treatment; water use; water velocity; watershed; waterway; wetland |
| Wastewater | activated sludge; anammox; biosolid; granular sludge; membrane bioreactor; mine water; |
| | sequencing batch reactor; sewage; sewer; waste stream; wastewater; wastewater treatment |
| | process |

### Additional Notes:

Many initial surrogates are not included because there are more influential surrogates can be used to label the same papers. For example, “phosphorus recovery” is not used because “wastewater” covered all of the relevant papers.
Glacier and snowpack are grouped to the soil domain in this study.
“sediment” belonged to the soil domain when it appeared together with water-related surrogates.
Hazardous wastes (e.g., electronic waste, nuclear waste) are also included in the solid waste domain.

TABLE S12
Summary of the top ten keywords and their frequencies for the 12 major groups
(#papers ≥200, groups are ordered by number of papers).

| Top# | water | | soil | soil-water |
|---|---|---|---|---|
| 1 | water, 765 | emiss, 1325 | soil, 1144 | sediment, 690 |
| 2 | surface wat, 579 | particulate matt, 1106 | sorption, 574 | soil, 530 |
| 3 | drinking wat, 494 | particl, 600 | sediment, 435 | water, 430 |
| 4 | toxic, 390 | aerosol, 561 | water, 327 | surface wat, 425 |
| 5 | oxid, 364 | air, 464 | organic compound, 313 | groundwat, 399 |
| 6 | groundwat, 363 | air pollut, 457 | pah, 281 | sorption, 354 |
| 7 | kinet, 361 | atmospher, 430 | humic subst, 255 | transport, 254 |
| 8 | sorption, 338 | pah, 425 | bioavail, 225 | iron, 226 |
| 9 | remov, 333 | oxid, 392 | degrad, 206 | organic compound, 224 |
| 10 | exposur, 308 | secondary organic | transport, 200 | contamin, 220 |
| | | aerosol, 388 | | |

| Top# | water-wastewater | wastewater | air-water | air-soil-water |
|---|---|---|---|---|
| 1 | wastewat, 613 | wastewat, 448 | surface wat, 174 | surface wat, 215 |
| 2 | surface wat, 264 | wwtp, 238 | water, 126 | sediment, 160 |
| 3 | wwtp, 218 | remov, 236 | atmospher, 107 | soil, 128 |
| 4 | drinking wat, 205 | activated sludg, 142 | pcb, 102 | water, 91 |
| 5 | remov, 197 | degrad, 131 | emiss, 98 | pcb, 90 |
| 6 | pharmaceut, 194 | bacteria, 116 | air, 98 | pah, 81 |
| 7 | water, 155 | oxid, 114 | usa, 77 | deposit, 79 |
| 8 | aquatic system, 125 | water, 110 | pah, 74 | transport, 77 |
| 9 | fate, 117 | system, 92 | persistent organic pollut, 71 | contamin, 74 |
| 10 | degrad, 109 | sorption, 88 | particulate matt, 65 | organic compound, 69 |

| Top# | air-soil | soil-water-wastewater | solid waste | air-solid waste |
|---|---|---|---|---|
| 1 | soil, 255 | wastewat, 150 | wast, 61 | emiss, 74 |
| 2 | emiss, 113 | sediment, 97 | msw, 40 | fly ash, 67 |
| 3 | pah, 100 | surface wat, 92 | china, 35 | pcdd/pcdfs, 63 |
| 4 | air, 90 | soil, 73 | electronic wast, 30 | combust, 61 |
| 5 | pcb, 89 | fate, 72 | pbde, 29 | dibenzo p dioxin, 51 |
| 6 | atmospher, 82 | sorption, 54 | system, 25 | china, 38 |
| 7 | particulate matt, 72 | wwtp, 48 | sorption, 24 | msw, 37 |
| 8 | deposit, 69 | remov, 45 | manag, 24 | inciner, 34 |
| 9 | sediment, 59 | pharmaceut, 44 | energi, 23 | pcb, 29 |
| 10 | model, 59 | degrad, 41 | product, 23 | waste inciner, 28 |

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof.

What is claimed is:

1. A method of processing an unstructured collection of text-based content items to automatically derive therefrom a trend-indicative representation of topical information, the method comprising:
pre-processing text within each of the text-based content items in accordance with presentation-norming and text-norming to provide a structured collection of the text-based content items, the presentation-norming comprising detection and combination of principle terms, the text-norming comprising word stemming;
automatically selecting keywords in accordance with a keyword usage frequency analysis and a keyword co-occurrence analysis of the content items within the structured collection of the text-based content items;
dividing the structured collection of the text-based content items into at least one of spatial, topical, geographical, demographical, and temporal groups of structured text-based content items;
determining for each keyword a respective normalized cumulative keyword frequency (Fᵥₐᵣ), normalized cumulative keyword frequency for variable p (F_{var p}), normalized cumulative keyword frequency for variable q (F_{var q}), and trend factor; and
generating an information product depicting the major and minor domains of interest.

2. The method of claim 1, further comprising identifying, using rules-based classification, major and minor domains of interest within the structured collection of the text-based content items.

3. The method of claim 1, wherein the presentation-norming further comprises excess component removal.

4. The method of claim 2, wherein the presentation-norming further acronym identification and replacement.

5. The method of claim 3, wherein the presentation-norming further comprises term recognition and unification.

6. The method of claim 3, wherein the text-norming further comprises lemmatization.

7. The method of claim 1, further comprising automatically selecting keywords in accordance with a user defined variance analysis of the content items within the collection of content items.

8. The method of claim 1, further comprising automatically selecting keywords in accordance with one or more target domain classifications.

9. The method of claim 1, wherein:
$${F}_{var} = \frac{{\sum }_{var = i}^{j} {f}_{var}}{{\sum }_{var = i}^{j} {N}_{var}} ( if i \neq j ) = \frac{{f}_{i}}{{N}_{i}} ( if i = j ) ;$$
$${F}_{var p} = α \times \frac{{\sum }_{FIRST p 1}^{LAST p 2} {f}_{var p}}{{\sum }_{FIRST p 1}^{LAST p 2} {N}_{var p}} ;$$
$${F}_{var q} = α \times \frac{{\sum }_{FIRST q 1}^{LAST q 2} {f}_{var q}}{{\sum }_{FIRST q 1}^{LAST q 2} {N}_{var q}} ; and$$
$$Trend factor = log ( \frac{{F}_{var q}}{{F}_{var p}} ) .$$

10. The method of claim 1, wherein the unstructured collection of text-based content items is identified via a customer request, the method further comprising:
responsive to the customer request, automatically gathering each of the content items within the unstructured collection of text-based content items.

11. The method of claim 1, wherein the information product comprises a visual representation of groups of structured text-based content items.

12. The method of claim 1, wherein the text comprises at least one of a title, abstract, one or more keywords, and deep text of at least one text-based content item.

13. The method of claim 1, wherein the trend factor comprises a logarithm value of the ratio of current normalized cumulative keyword frequencies to past normalized cumulative keyword frequencies.

14. The method of claim 2, wherein the rule-based classification scheme comprises an iterative selection of domain surrogates until a desired classification accuracy is achieved.

15. The method of claim 1, wherein co-occurrence analysis comprises frequency analysis of co-occurring items in the same content item.

16. The method of claim 1, wherein said automatically selecting keywords is further performed in accordance with an analysis of keyword association among different content items based on the same keyword.

17. A method of processing an unstructured collection of text-based content items to automatically derive therefrom a trend-indicative representation of topical information, the method comprising:
pre-processing text within each of the text-based content items in accordance with presentation-norming and text-norming to provide a structured collection of the text-based content items, the presentation-norming comprising detection and combination of principle terms, the text-norming comprising word stemming;
automatically selecting keywords in accordance with a keyword usage frequency analysis and a keyword co-occurrence analysis of the content items within the structured collection of the text-based content items;
identifying, using rules-based classification, major and minor domains of interest within the structured collection of the text-based content; and
generating an information product depicting the major and minor domains of interest.

18. The method of claim 17, further comprising:
dividing the structured collection of the text-based content items into at least one of spatial, topical, geographical, demographical, and temporal groups of structured text-based content items; and
determining for each keyword a respective normalized cumulative keyword frequency (Fᵥₐᵣ ), normalized cumulative keyword frequency for variable p (F_{var p}), normalized cumulative keyword frequency for variable q (F_{var q}), and trend factor.

19. The method of claim 17, wherein:
$${F}_{var} = \frac{{\sum }_{var = i}^{j} {f}_{var}}{{\sum }_{var = i}^{j} {N}_{var}} ( if i \neq j ) = \frac{{f}_{i}}{{N}_{i}} ( if i = j ) ;$$
$${F}_{var p} = α \times \frac{{\sum }_{FIRST p 1}^{LAST p 2} {f}_{var p}}{{\sum }_{FIRST p 1}^{LAST p 2} {N}_{var p}} ;$$
$${F}_{var q} = α \times \frac{{\sum }_{FIRST q 1}^{LAST q 2} {f}_{var q}}{{\sum }_{FIRST q 1}^{LAST q 2} {N}_{var q}} ; and$$
$$Trend factor = log ( \frac{{F}_{var q}}{{F}_{var p}} ) .$$

20. An apparatus, comprising processing resources and non-transitory memory resources, the processing resources configured to execute software instructions stored in the non-transitory memory resources to provide thereby a network function (NF), the core network function configured to perform a method of processing an unstructured collection of text-based content items to automatically derive therefrom a trend-indicative representation of topical information, the method comprising:
pre-processing text within each of the text-based content items in accordance with presentation-norming and text-norming to provide a structured collection of the text-based content items, the presentation-norming comprising detection and combination of principle terms, the text-norming comprising word stemming;
automatically selecting keywords in accordance with a keyword usage frequency analysis and a keyword co-occurrence analysis of the content items within the structured collection of the text-based content items;
dividing the structured collection of the text-based content items into at least one of spatial, topical, geographical, demographical, and temporal groups of structured text-based content items;
determining for each keyword a respective normalized cumulative keyword frequency (Fᵥₐᵣ), normalized cumulative keyword frequency for variable p (F_{var p}), normalized cumulative keyword frequency for variable q (F_{var q}), and trend factor; and
generating an information product depicting the major and minor domains of interest.

21. The apparatus of claim 20, wherein the method further comprises identifying, using rules-based classification, major and minor domains of interest within the structured collection of the text-based content items.
